(19) United States
(12) Patent Application Publication
(10) Pub. No.: US 2025/0196851 A1
(43) Pub. Date: Jun. 19, 2025

(54) CONNECTED VEHICLE SAFETY CONDITION DETECTION

(71) Applicant: UNIVERSITY OF SOUTH FLORIDA, Tampa, FL (US)

(72) Inventors: Srinivas KATKOORI, Tampa, FL (US); Omkar DOKUR, Tampa, FL (US); Gustavo OLENSCKI, Tampa, FL (US)

(21) Appl. No.: 18/986,578

(22) Filed: Dec. 18, 2024

Related U.S. Application Data
(60) Provisional application No. 63/611,695, filed on Dec. 18, 2023.
(60) Provisional application No. 63/611,706, filed on Dec. 18, 2023.
(60) Provisional application No. 63/611,716, filed on Dec. 18, 2023.

(51) Int. Cl. B60W 30/09; B60W 30/095; B60W 30/18; B60W 50/14; H04W 4/46

(52) U.S. Cl. CPC B60W 30/09; B60W 30/0956; B60W 30/18154; B60W 50/14; H04W 4/46; B60W 2520/10; B60W 2554/4041; B60W 2554/802; B60W 2555/60; B60W 2556/65

(57) ABSTRACT

A connected vehicle may receive a communication from an object, such as a vehicle or infrastructure object. The communication may include information such as an object position. The vehicle may determine a distance from the vehicle to the object based on the communication. The vehicle may further evaluate a distance condition based on the distance. The vehicle may determine a relative angle of the object from the vehicle and evaluate a relative angle condition based on the relative angle. The vehicle may detect a vehicle safety condition based on the distance condition and the relative angle condition. A warning or signal may be provided to a vehicle driver based on the detected condition. Alternatively, or additionally, an automated vehicle maneuver may be performed based on the detected condition.

### CROSS-REFERENCE TO RELATED APPLICATIONS

This application claims the benefit of U.S. Provisional Applications 63/611,695, 63/611,706, and 63/611,716, each filed on Dec. 18, 2023 and each incorporated in its entirety.

### STATEMENT REGARDING FEDERALLY SPONSORED RESEARCH OR DEVELOPMENT

N/A

### BACKGROUND

There exists a great number of scenarios and variables that are present in motor vehicle accidents, and the vast majority of such accidents are caused by human error. According to the United States Department of Transportation (USDOT), approximately 94% of all crashes in the US are attributed to human factors. National Highway Traffic Safety Administration (NHTSA) reports 37,473 and 36,560 traffic fatalities out of which 9,947 (27%) and 9,378 (26%) were due to speeding in 2017 and 2018 respectively. An NHTSA research note shows 36,096 traffic fatalities and 9,478 were due to speeding in 2019. Apart from fatalities due to speeding, other serious types of collisions include rear-end, head-on, and red-light running by drivers. Regarding rear-end collisions, it can be difficult to determine the speed of a vehicle ahead when driving at high speeds. Failure to notice when a leading vehicle is coming to a stop can result in a fatal collision. Vehicles that suddenly turn right may also cause rear-end collisions, especially when the driver performing said maneuver fails to turn on blinkers. Also, stationary vehicles contribute to a great portion of rear-end collisions as drivers fail to notice a stationary vehicle ahead. An Insurance Information Institute (III) report from 2019 shows that about 10.9% and 7.1% of all fatal crashes in the United States are head-on and rear-end collisions respectively. Further, rear-end collisions account for approximately 29% of all crashes in the United States, and the majority of such accidents involve a leading vehicle decelerating. But, all of these accidents can be avoided if these violations can be identified and notified in advance to all the people involved using connected vehicle (CV) technology.

Another type of crash leading to severe injuries and fatalities is a head-on crash. Head-on collisions can occur for a variety of causes. For head-on collisions that occur on two-lane two-way rural roads, it is possible to narrow down the factors that contribute to a crash. Drivers attempting to pass or overtake another driver often misjudge the possibility of safely doing so, which can lead to catastrophic head-on collisions. Another common reason is often a poor line of sight of the driver attempting the overtake, which makes it difficult to visualize the vehicle approaching in the opposite direction due to a large leading vehicle, or even poor weather conditions. Another cause for head-on collisions is due to wrong-way driving (WWD) on the roadways. These occur when drivers enter freeways from the incorrect side or when they drive against the lawful flow of traffic and hit a vehicle going the right way, endangering their safety as well as the other vehicles in the vicinity. Even though these crashes make up a relatively small percentage of all collisions, they result in serious injuries or fatalities. As per the Federal Highway Administration (FHWA), every year more than 400 people are killed in WWD crashes in the United States (US) making it a persistent problem.

Apart from crashes due to speeding, rear-end, and head-on collisions, one of the fatal crashes that frequently occur in the US is due to red light violations (RLVs) by red-light-running (RLR) drivers. These violations lead to thousands of injuries and hundreds of fatalities at intersections. An RLV is committed if the driver enters an intersection after the signal light has turned red. According to Insurance Institute for Highway Safety (IIHS), roughly 116,000 people were injured in 2020 due to RLR out of which 928 people lost their lives. Half of these deaths included bicyclists, pedestrians, and people present in vehicles that were hit by violators.

### BRIEF DESCRIPTION OF THE DRAWINGS

The foregoing features of embodiments will be more readily understood by reference to the following detailed description, taken with reference to the accompanying drawings, in which:

FIG. 1 illustrates a method of detecting a vehicle safety condition with respect to another vehicle or infrastructure element.

FIGS. 2A-2D illustrate examples of vehicle positions in traffic to illustrate various aspects of the described technology.

FIG. 3A illustrates an example method of detecting a vehicle within another vehicle's blind spot.

FIG. 3B illustrates an example method of detecting an emergency braking condition.

FIG. 3C illustrates an example method of detecting a forward collision condition.

FIG. 4 illustrates a method of detecting a vehicle safety condition with respect to another vehicle or infrastructure element.

FIGS. 5A-5D illustrate examples of vehicle positions in traffic to illustrate various aspects of the described technology.

FIGS. 6A-6b illustrate examples of vehicle positions with respect to infrastructure elements including traffic lights and roadside communication units to illustrate various aspects of the described technology.

FIG. 7A illustrates a method of detecting a slow-moving vehicle condition.

FIG. 7B illustrates a method of detecting a do-not-pass condition.

FIG. 7C illustrates a method of detecting various intersection-related vehicle conditions.

FIG. 7D illustrates a method of detecting a lane-change availability condition.

FIG. 7E illustrates a method of detecting a rear traffic jam formation condition.

FIG. 8A illustrates a method of detecting traffic light status-related conditions.

FIG. 8B illustrates a method of detecting a wrong way condition.

FIG. 9 illustrates an example environment illustrating aspects of a vehicle communication infrastructure.

FIG. 10 illustrates an example system to implement various aspects of the described technology.

### DETAILED DESCRIPTION

Approaches to vehicle safety condition detection may, in some cases, use sensor-based approaches, such as camera, radar, lidar, etc. and/or assume that connected vehicles are in the same lane. These sensor based approaches may present various challenges, such as poor performance in inclement weather conditions. Approaches that assume vehicle positions may lack robustness or practicality. Also, existing connected methods to prevent red light violations include red light prediction models developed using radar sensor data, which may suffer from performance issues (e.g., in inclement weather). Other approaches may include connected vehicle technology that detects and alerts the driver with a red light violation warning. In some cases, the red light may be detected using a sensor installed on the vehicle that may be affected by the changing weather conditions. Also, it may be ambigious if the red light detected is actually ahead of the approaching vehicle. This could lead to false alerts thereby affecting the driver's behavior.

One way in which vehicle-to-vehicle communication can take place is through platforms that utilize Dedicated Short Range Communication. Dedicated Short Range Communication (DSRC) is a low latency, wireless communication technology that is usable for vehicle-to-vehicle (V2V) and vehicle-to-infrastructure (V2I) communication in transportation systems. It operates in the 5.9 GHz frequency band, designated for automotive safety and mobility applications. The DSRC platform can be more limited in range (e.g., 100 meters, 200 meters, 300-500 meters, 750 meters, 1000 meters, etc.) in comparison to cellular or similar data communication platforms, but is more robust. In the United States, the Federal Communications Commission has allocated 75 MHz of spectrum in the 5.9 GHz band exclusively for DSRC, ensuring minimal interference from other wireless devices. And, being a vehicle-to-vehicle communication platform, it is not dependent on cellular tower location or uptime, network traffic restrictions, or other infrastructure limitations. Importantly, DSRC is far more weather-independent and insulated from other interference, than sensors such as LIDAR and optical cameras.

One type of communication that occurs over DSRC is known as “Basic Safety Messages” or the “BSM” protocol. Basic Safety Messages are standardized data packets exchanged between vehicles (Vehicle-to-Vehicle, or V2V) or between vehicles and roadside infrastructure (Vehicle-to-Infrastructure, or V2I). In terms of packet communication, BSMs can have multiple parts to each packet, multiple rates of packet transmission, and/or multiple packet types. For example, one part of a packet, or packet type, may have frequently updated, safety-critical data transmitted regularly at high rates, such as vehicle position, speed, heading, acceleration, brake status, vehicle size/dimension, etc. Another part of a packet, or packet type, may contain additional, event-driven information that is transmitted whenever necessary, such as when adverse weather or interference is detected or emergency maneuvers are taken, needed, or detected. The event-drive information may include information such as path history, path prediction, event flags (hard braking, airbag deployment, etc.), environmental information, and vehicle feature and sensor states (e.g., tire pressure, wiper status, headlight status, ABS operation, AWD status, etc.).

BSMs can be transmitted at regular intervals or at dynamic intervals. For example, in some situations they may be transmitted by a given vehicle every 10 seconds, 1 second, 100 miliseconds, 10 miliseconds, etc. In other situations they may be transmitted at dynamic intervals. For example, if no other vehicles are in range to respond, the broadcast rate may be decreased, and if other vehicles are in range they may be broadcast more frequently. The messages are generally broadcast directly to other vehicles, but may also be received by nearby infrastructure—in either case a centralized tower or server is not required.

Aspects of the described technology may perform vehicle safety condition detection based on messages exchanged between connected vehicles or between connected vehicles and infrastructure objects. For instance, aspects of the disclosed technology may provide V2V and V2I (Vehicle-to-infrastructure) warning applications that use only exchanged messages (e.g., Basic Safety Messages (BSMs)) to detect conditions. The use of such V2X communication may be independent of, or a supplement to, other vehicle safety condition detection protocols (e.g., those using active sensing modalities such as computer vision, radar, lidar, sonar, etc.).

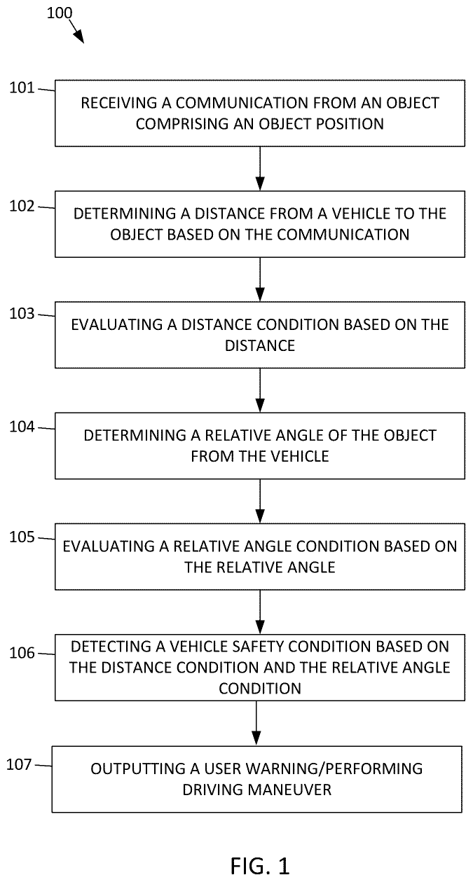

FIG. 1 illustrates an example method 100 for detecting a vehicle safety condition. In some examples, method 100 may be performed by a vehicle, such as via an onboard control unit (OBU), such as a vehicle control unit (VCU). For example, method 100 may be performed as an aspect of a driver warning system, a self-driving vehicle control system, etc. As another example, method 100 may be performed externally to a vehicle, such as at a server or other remote computer, as an aspect of a remote vehicle control system, etc. For ease of explanation, method 100 may be described as performed by a “host vehicle.” Unless context indicates otherwise, the description encompasses remote execution with respect to the host vehicle. Further, with respect to V2V examples, the second vehicle may be referred to as a “remote vehicle.” As examples, method 100 may comprise detecting a potential forward collision, an emergency electronic brake light condition (EEBL), a blind spot condition (e.g., a second vehicle in the host vehicle's blind spot), a slow moving vehicle (SMV) condition, a do-not-pass condition (DNP), an intersection crossing condition (e.g. a second vehicle potentially crossing the path of the host vehicle), a lane-change assistive condition (e.g., detection of availability of a safe lane change), a traffic light status condition, a red light warning condition, a wrong-way warning condition, etc.

Example method 100 may include block 101, which includes receiving a communication from an object that includes an object position. For example, block 101 may comprise receiving a broadcast or other wireless signal from the object, such as a Basic Safety Message (BSM). For instance, block 101 may comprise receiving a message according to a dedicated short range communication protocol, such as SAE J2735. As another example, block 101 may comprise receiving a cellular communication, such as a 5G V2X communication such as a ultra-reliable low latency communication (URLLC). In some examples, the object may comprise a second vehicle. In some examples, the object may comprise a road-side infrastructure component, such as a red light, a road sign, a pylon, a guard rail, etc. For instance, the object may comprise a roadside communication unit (RSU) to broadcast BSMs. In some examples, the communication may include the position of the object. For instance, a vehicle or infrastructure object may broadcast its position, which may be received as an aspect of block 101. For example, a vehicle or infrastructure object may comprise a satellite positioning system (e.g., a global positioning system (GPS)), which it may broadcast as a field in a BSM. As another example, a fixed object, such as an infrastructure object, may have a preprogrammed position, which it may transmit to vehicles. In some cases, the object position may be the position of an object associated with but not co-located with the communication transmission system. For instance, an RSU located at a corner of an intersection may broadcast traffic light information for traffic lights within the intersection. As another example, an RSU for wrong-way detection may be located at the side of a road but may broadcast a position associated with a lane or lanes of traffic.

In some examples, block 101 may comprise receiving other information beyond position. For example, block 101 may comprise receiving, from a remote vehicle, a remote vehicle velocity, acceleration, heading, turn-signal status, braking status, steering wheel angle, position accuracy, path history, predicted path information, event flags, physical characteristics (e.g., vehicle length/width), etc. Further, block 101 may be repeated to receive multiple communications. For instance, V2X communications may be transmitted by devices multiple times per second, and method 100 may be repeated for each received V2X communication, for a sampled subset of received V2X communications, on demand, etc.

In some examples, method 100 may include block 102, which may include determining a distance from a vehicle to the object based on the communication. For example, block 102 may comprise a host vehicle retrieving its position (e.g., via a satellite positioning system, etc.) and comparing its position to the received object position. For example, block 102 may comprise determining a position vector between the vehicle and object and determining the length of the position vector. As another example, block 102 may comprise computing a distance metric between the vehicle and object. In some examples, the distance comprises a distance in 3-space (e.g., based on latitude, longitude, and height coordinates of both objects). For example, the distance may comprise a distance computed without respect to height (e.g., based on the latitude and longitude of the objects).

In some examples, method 100 may include block 103, which may include evaluating a distance condition based on the distance. For example, block 103 may comprise comparing the distance to a threshold, determining if the distance is within a particular range, etc. In some examples, the distance condition may correspond to a particular vehicle safety condition that is being evaluated. In some cases, the distance condition may be based on a predetermined system parameter. In further cases, the distance condition may be based on a user configurable parameter. For example, a user configurable parameter may indicate a preferred following distance, a preferred stopping force/distance, etc. In some cases, the distance condition may be independent of a particular type of host vehicle. In other examples, the distance parameter may depend, at least in part, on the type of host vehicle. For instance, a sedan may have a smaller threshold distance for a forward collision warning than a semi-trailer truck, etc.

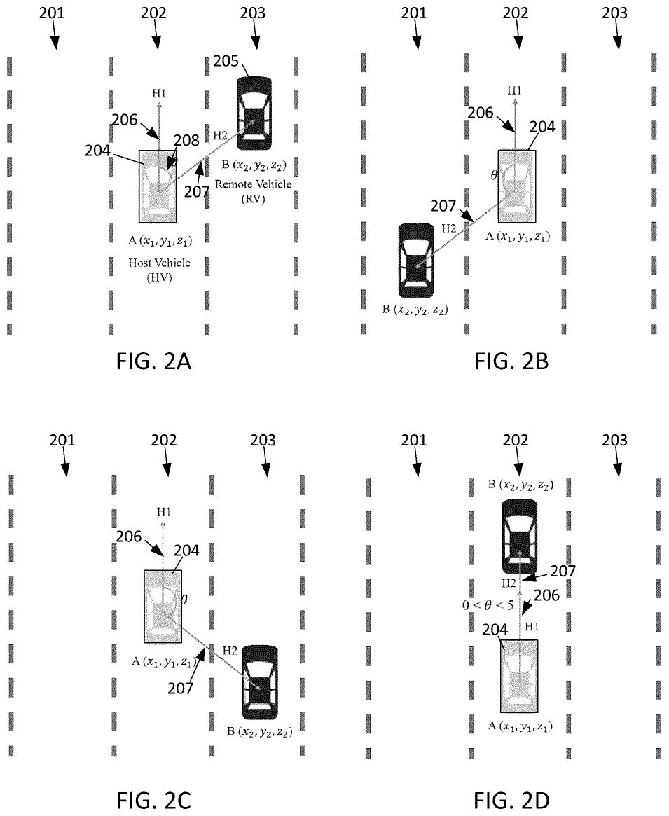

In some examples, method 100 may include block 104, which may include determining a relative angle of the object from the vehicle. In some examples, the relative angle may be determined based on the heading of the host vehicle and the positions of the host vehicle and the object. For example, the relative angle may comprise an angle between the heading of the host vehicle and a position vector between the vehicle and object. For instance, FIGS. 2A-2D illustrate various examples of relative angles between a host vehicle and a remote vehicle. FIGS. 2A-2D illustrate two vehicles, a host vehicle 204 and a remote vehicle 205 traveling in the same direction on a three lane 201, 202, 203 road. For example, if a host vehicle 204 located at A=(x1, y1, z1) heading in H1 206, receives a BSM from a remote vehicle 205 located at B=(x2, y2, z2), the relative angle, ‘θ’ 208, may be obtained by computing a vector 207 between the two points, AB=(x2−x1, y2−y1, z2−z1). The heading H2 of the vector AB 207 relative to the H1 (e.g., the y-axis in an example cartesian coordinate system centered at (x1, y1)) is computed. With H1 206 and H2 207, the relative angle θ 208 between the host vehicle 204 and remote vehicle 205 is given as H2−H1. In some examples, block 104 may include computing additional information using the relative angle θ 208. For example, a predicted relative position, or a predicted trajectory of the remote vehicle may be determined.

In some examples, method 100 may include block 105, which may include evaluating a relative angle condition based on the relative angle. For example, evaluating the relative angle condition may comprise determining a lane position of the object with respect to the host vehicle. For instance, block 105 may comprise evaluating a relative angle indicative of an object being ahead in a different lane (e.g., FIG. 2A), behind in a different lane (e.g., FIGS. 2B, 2C), behind in the same lane, ahead in the same lane (e.g., FIG. 2D), crossing an intersection, etc. As described further below, various examples of block 105 may comprise comparing an absolute value of the relative angle to a threshold/threshold range. Unless context indicates to the contrary, comparing the absolute value of a relative angle to a threshold may be performed by calculating the absolute value and comparing it to positive numbers or it may be performed by comparing the relative angle to both a negative angle threshold and a positive angle threshold. Further, as indicated above, angles may be described herein as positive or negative, which refer to a clockwise or counterclockwise angular direction, respectively (e.g., positive angles run from 0° to 180° and negative angles from 0° to)−180°. This description is an aid to explanation and does not limit angles to any particular system of measurement. For example, positive angles may be angle values between 0° and 180° and negative angles may be angle values between 180° and 360°, etc.

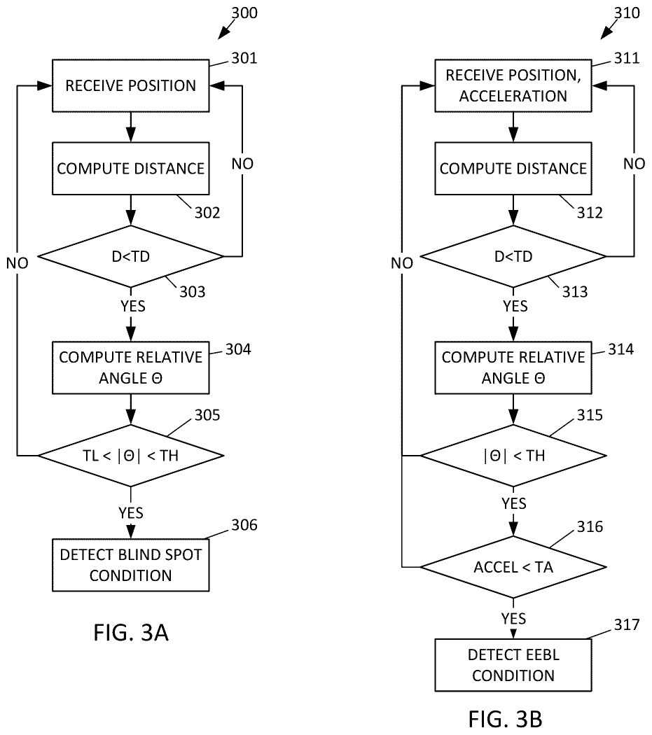

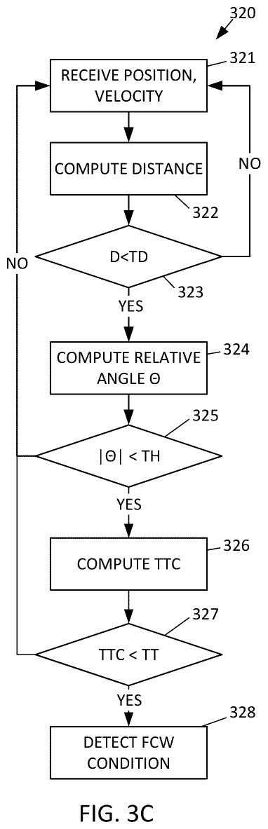

In some examples, method 100 may include block 106, which may include detecting a vehicle safety condition based on the distance condition and the relative angle condition. For example, FIGS. 3A-3C illustrate various examples of method 100 with respect to different vehicle safety conditions, which are based on respective distance and relative angle conditions.

In some examples, method 100 may include block 107, which may include taking action based on detecting the vehicle safety condition. For instance, block 107 may include logging the detected vehicle safety condition. As another example, block 107 may include outputting a user warning. For example, block 107 may comprise displaying an alert in a vehicle instrumentation system, issuing an audible signal, performing a haptic alert (e.g., vibrating a steering wheel or seat), etc. In these examples, the vehicle user may take action based on the outputted warning or may otherwise drive their vehicle in consideration of the warning. As another example, block 107 may include performing a driving maneuver based on the detected vehicle safety condition. For instance, block 107 may be performed via an automated driving system, such as an onboard or remote automated driving system. As examples, block 107 may comprise applying vehicle brakes, turning a vehicle steering wheel, issuing a traffic signal (e.g., turn signal lights), accelerating the vehicle, etc.

FIG. 3A illustrates an example 300 of method 100 comprising detecting a blind spot safety condition. For example, method 300 may comprise a host vehicle determining whether a remote vehicle is present in the vehicle's blind spot (e.g., an area around the vehicle that is not visible or easily visible by a driver at the vehicle controls). In this example, method 300 may comprise block 301, which may include receiving position information from a remote vehicle (e.g., as described with respect to block 101). Method 300 may further include block 302, which may include computing a distance to the remote vehicle (e.g., as described with respect to block 102).

In the illustrated example, method 300 may include block 303, which may include evaluating a distance condition. For example, in this example, block 303 may include determining if the distance is less than a threshold distance. For example, the threshold distance may be a typical distance between a vehicle and a neighboring lane in a particular angular range, the threshold distance may be a user configurable parameter, the threshold distance may be determined according to a particular vehicle or vehicle type (e.g., a small car may have a smaller distance threshold than a large truck), etc. For example, block 303 may include determining if the distance from first vehicle to the second vehicle is less than a threshold distance between 20 m and 30 m. For instance, the threshold distance may comprise 25 m or any other distance within the range. In the illustrated example, if the distance exceeds the threshold, then a blind spot condition is not detected (e.g., it is determined that there is likely no vehicle currently within the host vehicle's blind spots), and the method returns to block 301. For example, as described above, method 300 may be performed repeatedly while the host vehicle is moving. For instance, method 300 may be performed for each BSM received from a remote vehicle, for each of a sampled subset of received BSMs, etc.

As illustrated, method 300 include performing block 304 if the distance is less than the threshold distance in block 303. Block 304 includes calculating a relative angle θ between the host vehicle and the remote vehicle (e.g., as described with respect to block 104). Method 300 further comprises evaluating a relative angle condition based on the calculated relative angle θ. As illustrated, block 305 comprises determining if an absolute value of the relative angle is between a lower threshold and an upper threshold. For example, the lower threshold may comprise an angle threshold between 70° and 100°. For instance, the lower threshold may correspond to a vehicle directly to the side of the host vehicle (e.g., 90°), a vehicle a certain distance ahead and to the side of the host vehicle (e.g., θ<90°), or a vehicle to the side of and behind the host vehicle (e.g., θ>90°). For instance, the lower threshold may be 80°. In some examples, the upper threshold may correspond to a region to the side of the vehicle into which it would not be safe to merge if a remote vehicle were located in the region. For instance, the upper threshold may be between 135° and 155°, such as, for example, 145°. If the remote vehicle is at a relative angle outside the threshold range, then it is not present in the host vehicle's blind spot, and the method returns to block 301.

If the relative angle to the remote vehicle is in the range, then method 300 may include performing block 306. In block 306, a blind spot condition is detected based on the distance condition 303 and the relative angle condition 305 (e.g., as described with respect to block 106). In some examples, block 306 may further include issuing a blind spot warning, or executing an automated driving maneuver. For instance, block 306 may comprise providing feedback via the host vehicles steering wheel (e.g. by resisting the user turning the wheel to change lanes, by haptically vibrating the steering wheel, etc.), providing an audible warning (e.g., a tone or spoken phrase), providing a visual warning (e.g., activating a dashboard light, side mirror light, etc.), etc. As another example, block 306 may be performed by an automated driving system to determine whether the vehicle has clearance to change lanes.

In further examples, method 300 may include determining which blind spot of the host vehicle is occupied (e.g., the left-side blind spot or the right-side blind spot). For example, method 300 may comprise evaluating the sign of the relative angle to determine the occupied side. For example, if the relative angle may be calculated according to clockwise increasing angles, then positive relative angles (e.g., angles less than) 180° may correspond to the right side of the vehicle and negative relative angles (e.g., angles greater than) 180° may correspond to the left side of the vehicle. As another example, block 305 may comprise comparing the relative angle with a first pair of thresholds corresponding to the right vehicle side and comparing the relative angle with a second pair of thresholds corresponding to the left vehicle side. In some cases, the vehicle driver-side (e.g., left side in the United States) may have a smaller range than the vehicle passenger-side. In such examples, block 306 may comprise detecting a driver-side blind spot condition or a passenger-side blind spot condition. In these examples, block 306 may further comprise providing a warning indicative of the side or providing a respective driving maneuver according to the side.

FIG. 3B illustrates an example method 310 of detecting an emergency electronic brake light (EEBL) condition. For example, the condition may be indicative of hard braking occurring in the traffic ahead. For example, method 310 may comprise a host vehicle determining whether a remote vehicle which is present in the same lane ahead of the host vehicle is performing a hard brake. In this example, method 310 may comprise block 311, which may include receiving position information and acceleration information from a remote vehicle (e.g., as described with respect to blocks 101, 301). Method 310 may further include block 312, which may include computing a distance to the remote vehicle (e.g., as described with respect to blocks 102, 302).

In the illustrated example, method 310 may include block 313, which may include evaluating a distance condition. For example, in this example, block 313 may include determining if the distance is less than a threshold distance. For example, the threshold distance may be a distance where a host vehicle would be impacted by a hard braking event by a remote vehicle ahead of it (e.g., a distance where the host vehicle would be required to perform a hard brake, a distance proximal to a hard brake distance, etc.). For example, the threshold distance may be a user configurable parameter, the threshold distance may be determined according to a particular vehicle or vehicle type (e.g., a small car may have a smaller distance threshold than a large truck), etc. For example, block 313 may include determining if the distance from first vehicle to the second vehicle is less than a threshold distance between 40 m and 50 m. For instance, the threshold distance may comprise 45 m or any other distance within the range. In the illustrated example, if the distance exceeds the threshold, then an EEBL condition is not detected (e.g., it is determined that there is likely no remote vehicle sufficiently close to the host vehicle), and the method returns to block 311. For example, as described above, method 310 may be performed repeatedly while the host vehicle is moving. For instance, method 310 may be performed for each BSM received from a remote vehicle, for each of a sampled subset of received BSMs, etc.

As illustrated, method 310 include performing block 314 if the distance is less than the threshold distance in block 313. Block 314 includes calculating a relative angle θ between the host vehicle and the remote vehicle (e.g., as described with respect to block 104, 304). Method 310 further comprises evaluating 315 a relative angle condition based on the calculated relative angle θ. As illustrated, block 315 comprises determining if an absolute value of the relative angle is less than a threshold. For example, the threshold may be indicative of a remote vehicle in the same lane as the host vehicle. In some examples, the lower threshold may comprise an angle threshold between 2° and 8°. For instance, the threshold may be 5°. Of course, as described above, block 315 may comprise determining if the relative angle is between a first threshold between −2° and −8° and a second threshold between 2° and 8°. If the relative angle exceeds the threshold, then remote vehicle may be determined to be in a different lane (or behind) compared to the host vehicle, and the method may return to block 311.

In some examples, method 310 may include block 316, which may include evaluating an acceleration condition based on the second vehicle acceleration. For example, block 316 may comprise determining if the remote vehicle is performing a hard brake. For instance, block 316 may comprise determining if the remote vehicle is accelerating below a threshold lower than −0.3 g, −0.4 g, etc. As discussed above with respect to other thresholds, the acceleration threshold may be user configured, based on a host vehicle type, based on a typical safe margin, etc.

In some examples, method 310 may include block 317, which may include detecting the vehicle safety condition as an emergency electronic brake light condition based on the acceleration condition (e.g., block 106). In some examples, block 317 may further comprise outputting a warning or performing a driving maneuver (e.g., block 107). For example, block 317 may comprise outputting a visual warning, audible tone, haptic warnings, etc. As another example, block 317 may comprise performing a maneuver such as applying the host vehicle brakes, changing lanes, etc.

FIG. 3C illustrates an example method 320 of detecting a potential forward collision condition. For example, the condition may be indicative of potential collision with a remote vehicle in the host vehicle's path. In this example, method 320 may comprise block 321, which may include receiving position information and velocity information from a remote vehicle (e.g., from a BSM as described with respect to blocks 101, 301, 311). Method 320 may further include block 312, which may include computing a distance to the remote vehicle (e.g., as described with respect to blocks 102, 302, 312).

In the illustrated example, method 320 may include block 323, which may include evaluating a distance condition. For example, in this example, block 323 may include determining if the distance is less than a threshold distance. For example, the threshold distance may be a safe braking distance/avoidance distance for the host vehicle. For example, the threshold distance may be a user configurable parameter, the threshold distance may be determined according to a particular vehicle or vehicle type (e.g., a small car may have a smaller distance threshold than a large truck), etc. For example, block 323 may include determining if the distance from first vehicle to the second vehicle is less than a threshold distance between 40 m and 50 m. For instance, the threshold distance may comprise 45 m or any other distance within the range. In the illustrated example, if the distance exceeds the threshold, then an FC condition is not detected (e.g., it is determined that there is likely no remote vehicle sufficiently close to the host vehicle), and the method returns to block 321. For example, as described above, method 320 may be performed repeatedly while the host vehicle is moving. For instance, method 320 may be performed for each BSM received from a remote vehicle, for each of a sampled subset of received BSMs, etc.

As illustrated, method 320 include performing block 324 if the distance is less than the threshold distance in block 324. Block 324 includes calculating a relative angle θ between the host vehicle and the remote vehicle (e.g., as described with respect to block 104, 304, 314). Method 320 further comprises evaluating 325 a relative angle condition based on the calculated relative angle θ. As illustrated, block 325 comprises determining if an absolute value of the relative angle is less than a threshold. For example, the threshold may be indicative of a remote vehicle in the same lane as the host vehicle. In some examples, the lower threshold may comprise an angle threshold between 2° and 8°. For instance, the threshold may be 5°. Of course, as described above, block 325 may comprise determining if the relative angle is between a first threshold between −2° and −8° and a second threshold between 2° and 8° (e.g., between −5° and) 5°. If the relative angle exceeds the threshold, then remote vehicle may be determined to be in a different lane (or behind) compared to the host vehicle, and the method may return to block 321.

In some examples, method 320 may include block 326, which may include calculating a time-to-collision (TTC) condition based on the second vehicle velocity. For example, block 326 may comprise determining a time to collision given the host vehicle's velocity, the remote vehicle's velocity, and the distance between the vehicles (e.g., as distance/Av, where Av is the difference between the two velocities). In some examples, method 320 may further include block 327, which includes evaluating a TTC condition. For instance, block 327 may comprise determining if the TTC is below a threshold time, such as a threshold between 1 and 5 seconds. As discussed above with respect to other thresholds, the TTC threshold may be user configured, based on a host vehicle type, based on a typical safe margin, etc. (e.g., a truck may have a higher TTC threshold than a motorcycle, etc.).

In some examples, method 320 may include block 238, which may include detecting the vehicle safety condition as a potential forward collision with the second vehicle based on the time-to-collision condition (e.g., block 106). In some examples, block 328 may further comprise outputting a warning or performing a driving maneuver (e.g., block 107). For example, block 328 may comprise outputting a visual warning, audible tone, haptic warnings, etc. As another example, block 328 may comprise performing a maneuver such as issuing a hard brake warning in a host vehicle BSM, applying the host vehicle brakes, changing lanes, etc.

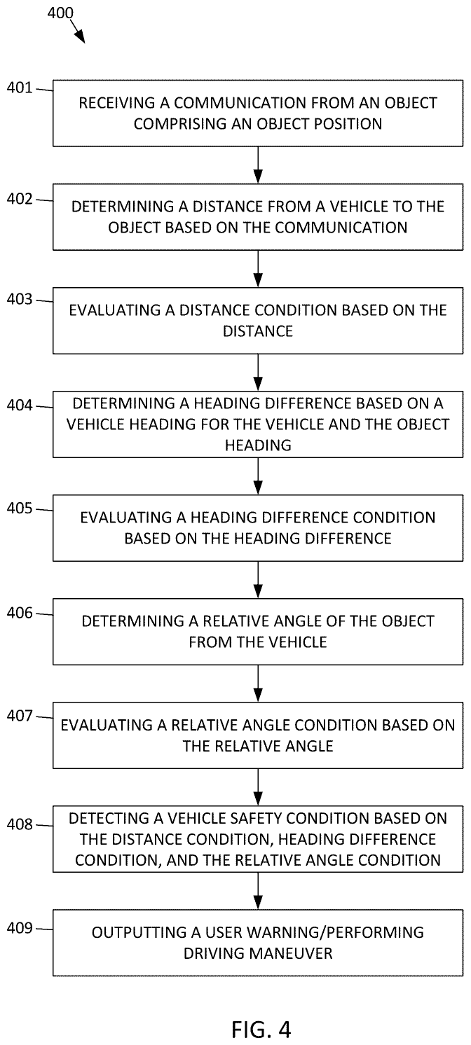

FIG. 4 illustrates an example method 400 including detecting a vehicle safety condition based on a heading difference between a host vehicle heading and an object heading. For example, for an object comprising a remote vehicle, the heading may comprise the direction in which the remote vehicle is traveling (or directed towards). As another example, for an object comprising an infrastructure element, the object heading may comprise an orientation of the object, direction of a road associated with the object, etc. For instance, a heading of a RSU may be calibrated in such a way that it is opposite to the flow of traffic. In some examples, method 400 may comprise an implementation of method 100. For example, blocks 401, 402, 403, 406, 407, 408, and 409 may be implemented as described with respect to blocks 101, 102, 103, 104, 105, 106, and 107 respectively.

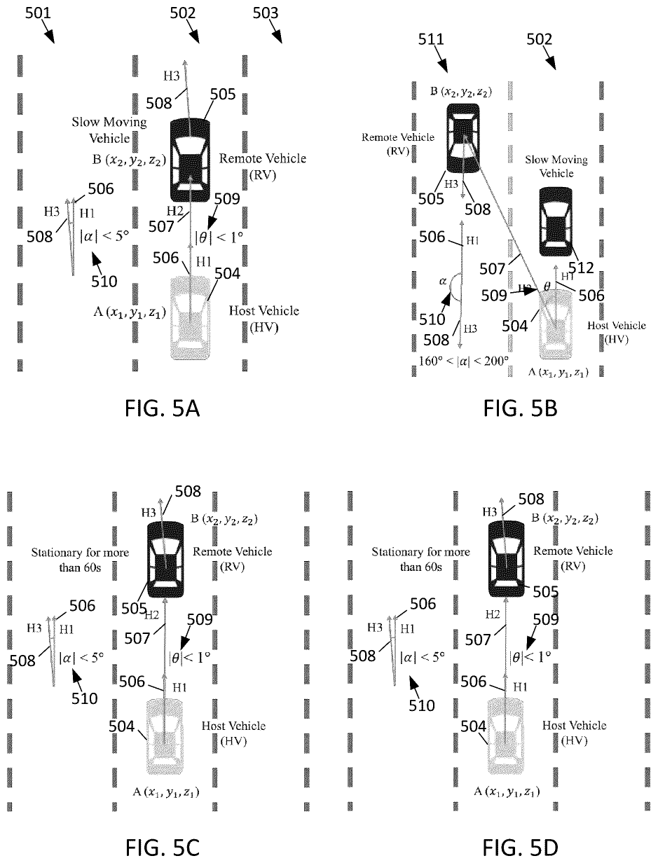

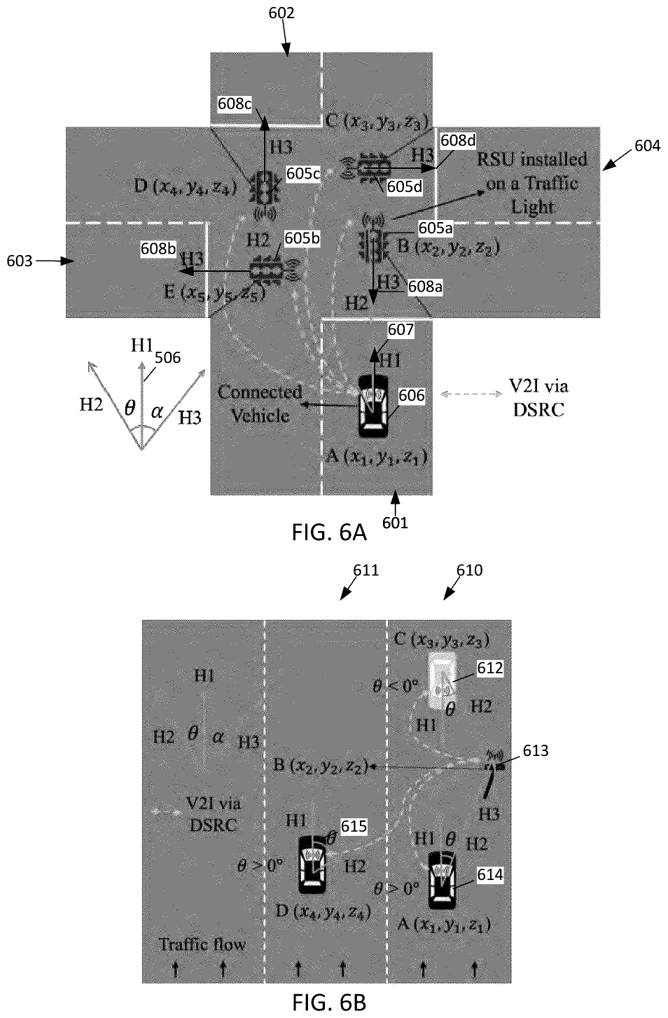

In some examples, method 400 may include block 404, which may include determining a heading difference between the object and the vehicle. In some examples, the heading difference may comprise an angle determined based on the headings of the host vehicle and the object. For example, the heading difference may comprise an angle between the heading of the host vehicle and the heading of the object. For instance, FIGS. 5A-5D illustrate various examples of heading differences between a host vehicle and a remote vehicle, FIG. 6A illustrates an example of heading difference between a host vehicle and an infrastructure element (e.g., traffic light), and FIG. 6B illustrates an example of a host vehicle traveling the wrong way down a road with a roadside beacon 613. FIGS. 5A-5D illustrate two vehicles, a host vehicle 504 and a remote vehicle 505. In FIGS. 5A, 5C, 5D, vehicles 504, 505 travel in the same direction on a three lane 501, 502, 503 road, and in FIG. 5B, vehicles 504, 505 travel in opposite directions, with remote vehicle 505 in an opposing lane 511 of the road. For example, if a host vehicle 504 located at A=(x1, y1, z1) heading in H1 506, receives a BSM from a remote vehicle 505 located at B=(x2, y2, z2), the heading difference, ‘α’ 510, may be obtained by computing the angular difference between heading H1 506 and the remote vehicle 505 heading 508 (H3). As further illustrated, a relative angle 509 may be calculated (e.g., as described with respect to block 104 and FIGS. 2A-2D). The heading H2 507 of the vector AB relative to the H1 506 (e.g., the y-axis in an example cartesian coordinate system centered at (x1, y1)) is computed. With H1 506 and H2 507, the relative angle θ 509 between the host vehicle and the remote vehicle is given as H2-H1.

As illustrated in FIG. 6A, a host vehicle 606 is approaching an intersection of four lanes 601, 602, 603, 604. In this example, infrastructure objects comprise traffic lights 605a-605d, having headings opposing traffic. For example, traffic light 605a is in the lane 601 of host vehicle 606 and has a heading opposing traffic 608a (e.g., towards host vehicle 6060), traffic light 605b has a heading 608b opposing traffic on lane 603, traffic light 605c has a heading 608c opposing traffic on lane 602, and traffic light 605d has a heading 608d opposing traffic on lane 604. Here, a heading difference 506 may be calculated with respect to the traffic lights 605a-d. For instance, a heading difference α between host vehicle 606 and traffic light 605a may be calculated as H1 607-H3 608a (e.g., 0°-180°=−180°=180°).

As illustrated in FIG. 6B, a roadside beacon 613 broadcasts a BSM with information regarding the road. For example, beacon 613 may comprise an RSU installed on a street pole located at B (x2, y2, z2), two remote vehicles 614, 615 are traveling in the legal direction of traffic flow located at A (x1, y1, z1) and D (x4, y4, z4), and a host vehicle 612 is traveling in the wrong direction of traffic flow at C (x3, y3, z3). In this example, the RSU's 613 heading may calibrated so that its heading is opposite (180°) to the legal direction of traffic (e.g., similar to the heading of traffic lights 605a-d). With the help of V2I communication, the RSU 613 can transmit its heading and location information via BSMs that can be used by vehicles 615, 614, 612 to predict a wrong way condition. In this example, heading angle of each of these vehicles is H1 and RSU's is H3. New vectors are obtained by joining AB, CB, and DB whose heading angle is H2. The difference between the heading angles H1 and H2 (i.e., H1-H2) is the relative angle θ between a vehicle 612, and RSU 613, whereas the difference between H1 and H3 is the heading angle difference α between vehicle 612 and RSU 613 (e.g, H1-H3).

In some examples, method 400 may include block 405, which may include evaluating a heading difference condition based on the heading difference. For example, evaluating the heading difference condition may comprise determining the orientation of an object with respect to the host vehicle. For instance, block 405 may comprise evaluating a heading difference indicative of a vehicle traveling in the same direction (e.g., FIGS. 5A, 5C, 5D), traveling in an opposing direction (e.g., FIG. 5B), traveling in a different direction (e.g., different directions at an intersection), an infrastructure object oriented in an opposing direction (e.g., FIG. 6A, traffic light 605a), etc. As described further below, various examples of block 405 may comprise comparing an absolute value of the heading difference to a threshold/threshold range. Unless context indicates to the contrary, comparing the absolute value of a heading difference to a threshold may be performed by calculating the absolute value and comparing it to positive numbers or it may be performed by comparing the heading difference to both a negative angle threshold and a positive angle threshold. Further, as indicated above, angles may be described herein as positive or negative, which refer to a clockwise or counterclockwise angular direction, respectively (e.g., positive angles run from 0° to 180° and negative angles from 0° to −180°). This description is an aid to explanation and does not limit angles to any particular system of measurement. For example, positive angles may be angle values between 0° and 180° and negative angles may be angle values between 180° and 360°, etc. Further, for ease of explanation, heading angles may be described with respect to the direction of host vehicles (e.g., H1=) 0°. In deployments, headings may be calculated according to any shared reference direction (e.g., magnetic north, true north, etc.).

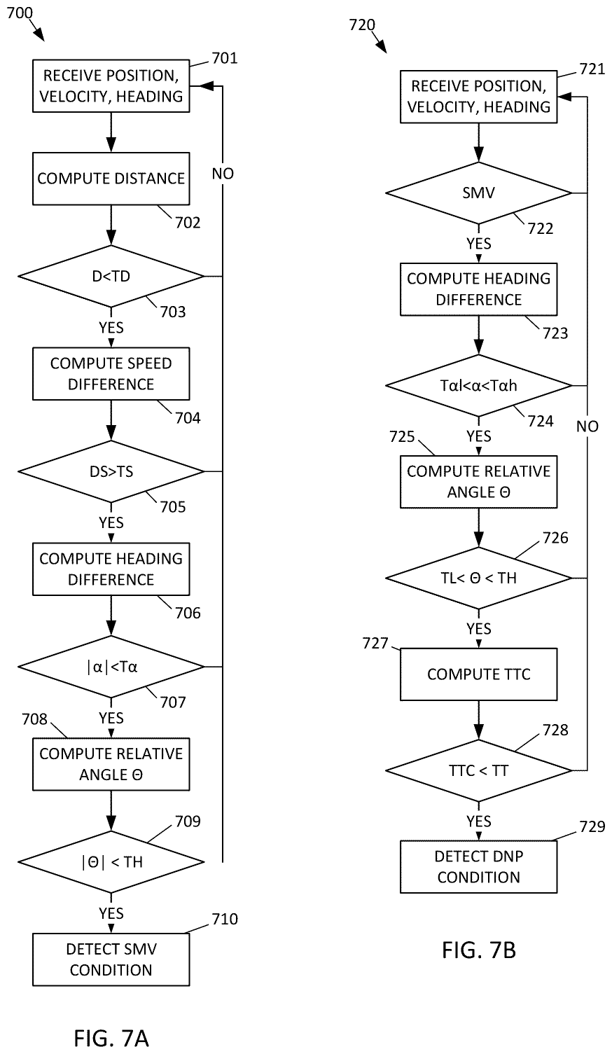

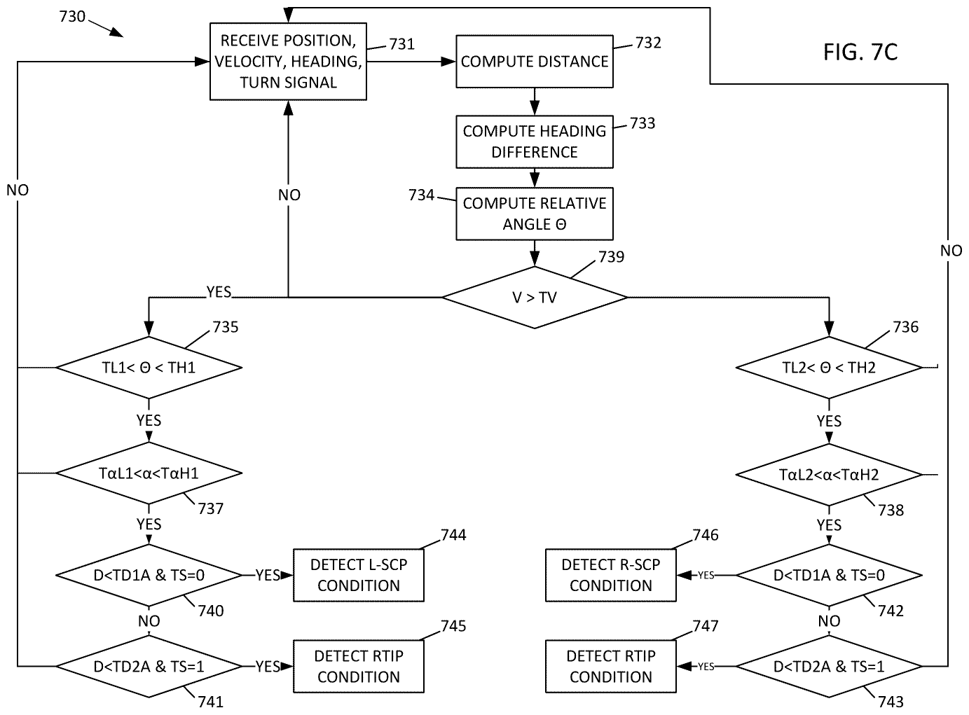

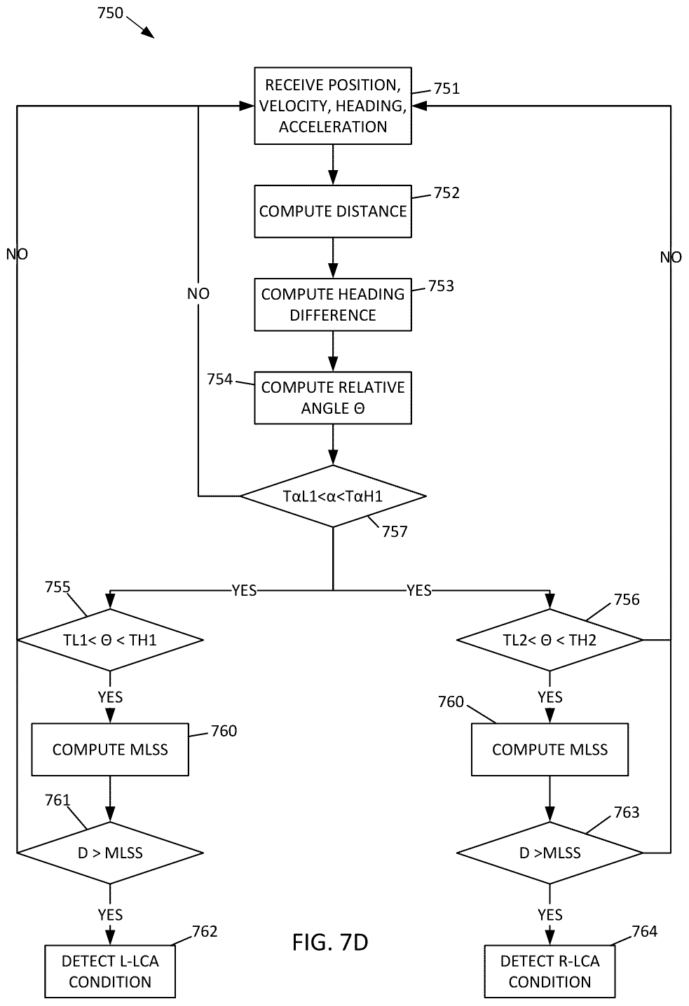

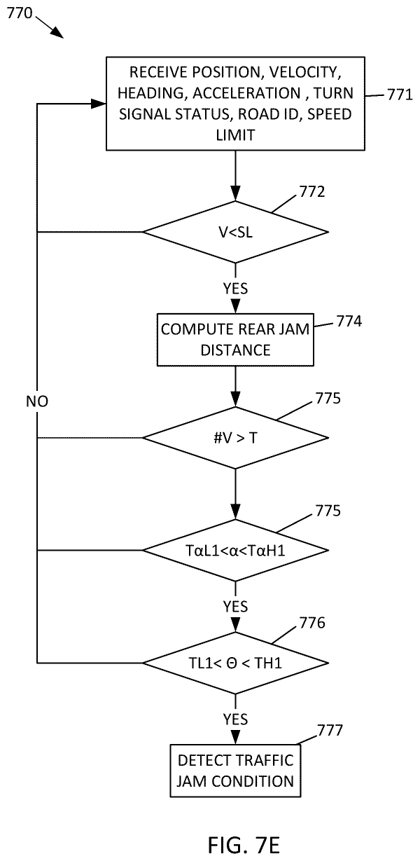

FIG. 7A illustrates an example method 700 of detecting a slow-moving vehicle (SMV) condition (e.g., a situation as illustrated FIG. 5B). For example, the condition may be indicative of slow-moving vehicle ahead in the same lane of traffic as the host vehicle. In this example, method 700 may comprise block 701, which may include receiving position, velocity, and heading information from a remote vehicle (e.g., as described with respect to blocks 101, 301, etc.). Method 700 may further include block 702, which may include computing a distance to the remote vehicle (e.g., as described with respect to blocks 102, 302, 402 etc.).

In the illustrated example, method 700 may include block 703, which may include evaluating a distance condition. For example, in this example, block 703 may include determining if the distance is less than a threshold distance. For example, the threshold distance may be a distance where a host vehicle would be impacted by a slower remote vehicle ahead of it (e.g., a distance where the host vehicle would be required to reduce speed, brake, etc.). For example, the threshold distance may be a user configurable parameter, the threshold distance may be determined according to a particular vehicle or vehicle type (e.g., a small car may have a smaller distance threshold than a large truck), etc. For example, block 703 may include determining if the distance from first vehicle to the second vehicle is less than a threshold distance between 40 m and 50 m. For instance, the threshold distance may comprise 45 m or any other distance within the range. In the illustrated example, if the distance exceeds the threshold, then an SMV condition is not detected (e.g., it is determined that there is likely no remote vehicle sufficiently close to the host vehicle), and the method returns to block 701. For example, as described above, method 700 may be performed repeatedly while the host vehicle is moving. For instance, method 700 may be performed for each BSM received from a remote vehicle, for each of a sampled subset of received BSMs, etc.

As illustrated, method 700 include performing block 704 if the distance is less than the threshold distance in block 703. Block 704 may include determining a speed difference between a speed limit and the second vehicle velocity. For example, a host vehicle may retrieve a speed limit from a BSM (e.g., a broadcast by an infrastructure object), retrieving the speed limit from a navigation system, retrieving a cruise-control setting, receiving a user input of the speed limit, etc. The host vehicle may retrieve the remote vehicle's speed from its BSM. Block 704 may further comprise determining the difference between the speed limit and the remote vehicle's speed based on these inputs. Method 700 further comprises block 705, which may include evaluating a speed difference condition based on the speed difference. For example, block 705 may comprise determining if the speed difference is greater than a speed difference threshold. For instance, the threshold may be user configured parameter, a preprogrammed system parameter, etc. In some examples, the threshold may be a speed between 0 km/hr and 40 km/hr (e.g., between 5 and 30 km/hr, such as, for example, 10 km/hr). If the speed difference is smaller than the threshold, then method 700 returns to block 701 (e.g., the detected vehicle is determined to be a non-slow-moving vehicle). If the speed difference is greater than the threshold, then method 700 proceeds to block 706.

Block 706 may include calculating a heading difference α between the host vehicle and the remote vehicle (e.g., as described with respect to block 404). Method 707 further comprises block 707, which includes evaluating a heading condition (e.g., as described with respect to block 405) the calculated heading difference α. As illustrated, block 707 includes determining if an absolute value of the heading difference is less than a first threshold angle indicative of the remote vehicle traveling in the same direction as the host vehicle. For example, the threshold angle may between 3° and 7° (e.g., 5°). If the difference exceeds the threshold, then method 700 returns to block 701 (e.g., a detected slow moving vehicle is traveling in a different direction). If the difference meets the threshold, then method 700 proceeds to block 708.

Block 708 includes calculating a relative angle θ between the host vehicle and the remote vehicle (e.g., as described with respect to block 104, 304, 406, etc.). Method 700 further comprises block 709, which includes evaluating a relative angle condition based on the calculated relative angle θ. As illustrated, block 709 comprises determining if an absolute value of the relative angle is less than a threshold. For example, the threshold may be indicative of a remote vehicle in the same lane as the host vehicle. In some examples, the lower threshold may comprise an angle threshold between 1° and 8°. For instance, the threshold may be 1°. If the relative angle exceeds the threshold, the method 700 may return to block 701 (e.g., the remote vehicle may be determined to be in a different lane than or behind the host vehicle).

In some examples, method 700 may include block 710, which may include detecting the vehicle safety condition as a slow-moving vehicle condition based on the conditions (e.g., block 106, 408, etc.). In some examples, block 710 may further comprise outputting a warning or performing a driving maneuver (e.g., block 107, 409, etc.). For example, block 710 may comprise outputting a visual warning, audible tone, haptic warnings, etc. As another example, block 710 may comprise performing a maneuver such as applying the host vehicle brakes, changing lanes, etc.

FIG. 7B illustrates an example method 720 of detecting a do-not-pass (DNP) condition. In this example, method 720 may be performed with respect to other remote vehicles after a first remote vehicle is determined to be a slow-moving vehicle. For example, with respect to the situation illustrated in FIG. 5B, method 720 may be performed with respect to remote vehicle 505 after method 700 detects vehicle 512 to be an SMV. In other examples, method 720 may be preformed independently of method 700 (e.g., without block 722), such as responsive to a user input, a turn signal indicative of a vehicle attempting to pass a vehicle. In this example, method 720 may comprise block 721, which may include receiving position, velocity, and heading information from a remote vehicle (e.g., as described with respect to blocks 101, 301, 401, 701, etc.). Method 720 may further include block 722, which may include performing method 700 to detect a slow-moving vehicle. For example, method 720 may be performed as an aspect of block 710 of FIG. 7A. If a slow moving vehicle is detected, method 720 may proceed to block 723.

Block 723 may include calculating a heading difference α between the host vehicle and the remote vehicle (e.g., as described with respect to blocks 404, 706). Method 720 further comprises block 724, which includes evaluating a heading condition based on the calculated heading difference α (e.g., as described with respect to block 405, 707). As illustrated, block 724 includes determining if the heading difference is between a lower heading threshold and a higher heading threshold indicative of the remote vehicle traveling towards the host vehicle. For example, the lower heading threshold may between 150° and 170° (e.g., 160°) and the upper heading threshold may be between 190° and 210° (e.g., 200°). If a is outside the range, then method 700 returns to block 701 (e.g., there is no oncoming vehicle in a neighboring lane). If a is within the range, then method 720 proceeds to block 725.

Block 725 includes calculating a relative angle θ between the host vehicle and the remote vehicle (e.g., as described with respect to block 104, 304, 406, etc.). Method 720 further comprises block 726, which includes evaluating a relative angle condition based on the calculated relative angle θ. As illustrated, block 726 comprises determining if the relative angle is within a range defined by an upper and lower threshold. For example, the range may be indicative of a remote vehicle in an oncoming traffic lane bordering the host vehicle's lane. In some examples, the lower threshold may comprise an angle threshold between −100° and −80° (e.g., −90°). In some examples, the upper threshold may comprise an angle threshold between 10° and −10° (e.g., 0°). If the relative angle is outside the range, the method 720 may return to block 721 (e.g., the remote vehicle may be determined to be outside the passing lane).

In some examples, method 720 may include block 727, which may include calculating a time-to-collision (TTC) condition based on the second vehicle velocity. For example, block 727 may comprise determining a time to collision given the host vehicle's velocity, the remote vehicle's velocity, and the distance between the vehicles (e.g., as distance/Av, where Av is the difference between the two velocities). In some examples, method 720 may further include block 728, which includes evaluating a TTC condition. For instance, block 728 may comprise determining if the TTC is below a safe passing threshold time. As discussed above with respect to other thresholds, the TTC threshold may be user configured (e.g., selected within a predetermined safe range), based on a host vehicle type, based on a typical safe margin, based on current velocity etc. (e.g., a faster moving vehicle may have a higher TTC threshold than a slower moving vehicle). If the TTC is less than the safe time threshold, then method 720 proceeds to block 729.

In some examples, block 729 may include detecting the vehicle safety condition as a DNP condition based on the conditions (e.g., block 106, 408, etc.). In some examples, block 729 may further comprise outputting a warning or performing a driving maneuver (e.g., block 107, 409, etc.). For example, block 729 may comprise outputting a visual warning, audible tone, haptic warnings, etc. As another example, block 729 may comprise performing a maneuver such as preventing or resisting a steering wheel from turning into the passing lane, etc.

FIG. 7C illustrates an example method 730 of detecting various vehicle safety conditions associated with a host vehicle entering an intersection. For example, method 730 may include detecting a remote vehicle crossing the intersection in front of the host vehicle or detecting a remote vehicle turning across the path of the host vehicle. In this example, method 730 may comprise block 731, which may include receiving position, velocity, turn signal status, and heading information from a remote vehicle (e.g., as described with respect to blocks 101, 301, 401, etc.). Method 730 may further include block 732, which may include computing a distance to the remote vehicle (e.g., as described with respect to blocks 102, 302, 402 etc.). Method 730 may further include block 733, which may include computing a heading difference between the host and remote vehicle (e.g., as described with respect to block 404, etc.) and block 734, which may include computing a relative angle between the host and remote vehicle (e.g., as described with respect to block 104, 304, 406, etc.).

In some examples, method 730 may include calculating a threshold velocity condition 739 indicative of the remote vehicle traveling through the intersection (e.g., sufficiently fast that the remote vehicle is likely not stopping). For example, the velocity threshold may be between 7 m/s and 15 m/s (e.g., 10 m/s). If the velocity meets the threshold condition, then the method proceeds to a left analysis branch beginning with block 735 and a right analysis branch beginning with block 736.

In some examples, block 735 may include evaluating a relative angle condition based on the calculated relative angle θ. As illustrated, block 735 comprises determining if the relative angle is within a range defined by an upper and lower threshold. For example, the range may be indicative of a remote vehicle entering an intersection from the left. For example, block 735 may include determining if the relative angle is between a first angle threshold between 0° and −2° (e.g., 0°) and a second angle threshold between −40° and −55 (e.g. −46°). If the relative angle is outside the range, the method 730 may return to block 731 (e.g., the remote vehicle may be determined to be not entering an intersection from the left). If the relative angle is within the range, method 730 may proceed to block 737.

Block 737 may include evaluating a heading condition based on the calculated heading difference α (e.g., as described with respect to block 405, 707). As illustrated, block 737 includes determining if the heading difference is between a lower heading threshold and a higher heading threshold indicative of the remote vehicle traveling into the intersection. For example, the first heading threshold (e.g., upper threshold for negative angles) may be between −70° and −85° (e.g., −78°) and the second heading threshold (e.g., lower threshold) may be between −90° and −100 (e.g., −93°). If a is outside the range, then method 737 returns to block 731. If a is within the range, then method 730 proceeds to block 740.

Block 740 may include determining if the distance is less than a threshold distance and if a turn signal is off. For example, the threshold distance may be a distance where a host vehicle would be impacted by the remote vehicle crossing the intersection in front of it (e.g., a distance where the host vehicle would be required to reduce speed, brake, etc.). For example, the threshold distance may be a user configurable parameter, the threshold distance may be determined according to a particular vehicle or vehicle type (e.g., a small car may have a smaller distance threshold than a large truck), etc. For example, block 740 may include determining if the distance from first vehicle to the second vehicle is less than a threshold distance between 40 m and 50 m. For instance, the threshold distance may comprise 45 m or any other distance within the range. In the illustrated example, if the distance exceeds the threshold the method proceeds to block 741.

If the distance meets the threshold, then method 730 may proceed to block 744, which may include detecting a (left) straight crossing path (SCP) condition (e.g., block 106, 408, etc.). In some examples, block 744 may further comprise outputting a warning or performing a driving maneuver (e.g., block 107, 409, etc.). For example, block 744 may comprise outputting a visual warning, audible tone, haptic warnings, etc. As another example, block 744 may comprise performing a maneuver such as lowering the host vehicle speed, applying the host vehicle brakes, etc.

Block 741 may include determining if the distance is less than a threshold distance and if a turn signal is on. For example, the threshold distance may be a distance where a host vehicle would be impacted by the remote vehicle turning in front of it (e.g., a distance where the host vehicle would be required to reduce speed, brake, etc.). For example, the threshold distance may be a user configurable parameter, the threshold distance may be determined according to a particular vehicle or vehicle type (e.g., a small car may have a smaller distance threshold than a large truck), etc. For example, block 741 may include determining if the distance from first vehicle to the second vehicle is less than a threshold distance between 60 m and 80 m (e.g., 70 m). In the illustrated example, if the distance exceeds the threshold or the turn signal status is false, then method 730 returns to block 731.

If the distance meets the threshold and the turn signal status is positive, then method 730 proceeds to block 745, which may include detecting a (right) turn into path (TIP) condition. In some examples, block 745 may further comprise outputting a warning or performing a driving maneuver (e.g., block 107, 409, etc.). For example, block 745 may comprise outputting a visual warning, audible tone, haptic warnings, etc. As another example, block 745 may comprise performing a maneuver such as lowering the host vehicle speed, applying the host vehicle brakes, etc.

Turning to the right analysis branch, block 736 may include evaluating a relative angle condition based on the calculated relative angle θ. As illustrated, block 736 comprises determining if the relative angle is within a range defined by an upper and lower threshold. For example, the range may be indicative of a remote vehicle entering an intersection from the right. For example, block 736 may include determining if the relative angle is between a first angle threshold between 0° and 2° (e.g., 0°) and a second angle threshold between 40° and 55° (e.g. 46°). If the relative angle is outside the range, the method 730 may return to block 731 (e.g., the remote vehicle may be determined to be not entering an intersection from the right). If the relative angle is within the range, method 730 may proceed to block 738.

Block 738 may include evaluating a heading condition based on the calculated heading difference α (e.g., as described with respect to block 405, 707). As illustrated, block 738 includes determining if the heading difference is between a lower heading threshold and a higher heading threshold indicative of the remote vehicle traveling into the intersection. For example, the first heading threshold (e.g., lower threshold for positive angles) may be between 70° and 85° (e.g., 78°) and the second heading threshold (e.g., upper threshold) may be between 90° and 100 (e.g., 93°). If a is outside the range, then method 730 returns to block 731. If a is within the range, then method 730 proceeds to block 742.

Block 742 may include determining if the distance is less than a threshold distance and if a turn signal is off. For example, the threshold distance may be a distance where a host vehicle would be impacted by the remote vehicle crossing the intersection in front of it (e.g., a distance where the host vehicle would be required to reduce speed, brake, etc.). For example, the threshold distance may be a user configurable parameter, the threshold distance may be determined according to a particular vehicle or vehicle type (e.g., a small car may have a smaller distance threshold than a large truck), etc. For example, block 742 may include determining if the distance from first vehicle to the second vehicle is less than a threshold distance between 40 m and 50 m. For instance, the threshold distance may comprise 45 m or any other distance within the range. In the illustrated example, if the distance does not meet the threshold the method proceeds to block 743.

If the distance meets the threshold, then method 730 may proceed to block 746, which may include detecting a (right) straight crossing path (SCP) condition (e.g., block 106, 408, etc.). In some examples, block 746 may further comprise outputting a warning or performing a driving maneuver (e.g., block 107, 409, etc.). For example, block 746 may comprise outputting a visual warning, audible tone, haptic warnings, etc. As another example, block 746 may comprise performing a maneuver such as lowering the host vehicle speed, applying the host vehicle brakes, etc.

Block 743 may include determining if the distance is less than a threshold distance and if a turn signal is on. For example, the threshold distance may be a distance where a host vehicle would be impacted by the remote vehicle turning in front of it (e.g., a distance where the host vehicle would be required to reduce speed, brake, etc.). For example, the threshold distance may be a user configurable parameter, the threshold distance may be determined according to a particular vehicle or vehicle type (e.g., a small car may have a smaller distance threshold than a large truck), etc. For example, block 743 may include determining if the distance from first vehicle to the second vehicle is less than a threshold distance between 60 m and 80 m (e.g., 70 m). In the illustrated example, if the distance exceeds the threshold or the turn signal status is false, then method 730 returns to block 731.

If the distance meets the threshold and the turn signal status is positive, then method 730 proceeds to block 747, which may include detecting a (left) turn into path (TIP) condition. In some examples, block 747 may further comprise outputting a warning or performing a driving maneuver (e.g., block 107, 409, etc.). For example, block 747 may comprise outputting a visual warning, audible tone, haptic warnings, etc. As another example, block 747 may comprise performing a maneuver such as lowering the host vehicle speed, applying the host vehicle brakes, etc.

FIG. 7D illustrates an example method 750 of detecting a lane change availability (LCA) condition. For example, method 750 may comprise determining if a host vehicle is a safe distance from a remote vehicle to move into the remote vehicle's lane. In this example, method 750 may comprise block 751, which may include receiving position, velocity, and heading information from a remote vehicle (e.g., as described with respect to blocks 101, 301, 401, etc.). Method 750 may further include block 752, which may include computing a distance to the remote vehicle (e.g., as described with respect to blocks 102, 302, 402 etc.). Method 750 may further include block 753, which may include computing a heading difference between the host and remote vehicle (e.g., as described with respect to block 404, etc.) and block 754, which may include computing a relative angle between the host and remote vehicle (e.g., as described with respect to block 104, 304, 406, etc.).

Method 750 may further include block 757, which may include evaluating a heading condition based on the calculated heading difference α (e.g., as described with respect to block 405, 707). As illustrated, block 757 includes determining if the heading difference is within a range indicative of the remote vehicle traveling the same direction as the host vehicle. For example, the first heading threshold may be between −3° and 0° (e.g., −1°) and a second heading threshold may be between 3° and 7° (e.g., 5°). If a is outside the range, then method 750 returns to block 751. If a is within the range, then method 750 proceeds to a left lane change analysis branch beginning with block 755 and a right lane change analysis branch beginning with block 756.

In some examples, block 755 may include evaluating a relative angle condition based on the calculated relative angle θ. As illustrated, block 755 comprises determining if the relative angle is within a range defined by an upper and lower threshold. For example, the range may be indicative of a remote vehicle approaching the host vehicle from a neighboring left lane. For example, block 755 may include determining if the relative angle is between a first angle threshold between −180° and −160° (e.g., −170°) and a second angle threshold between −80° and −60 (e.g., −70°). If the relative angle is outside the range, the method 750 may return to block 751. If the relative angle is within the range, method 750 may proceed to block 760.

Block 760 may comprise computing a minimum longitudinal safety space (MLSS). For example, the MLSS may be computed based on the velocity and acceleration of both vehicles and a time value for a vehicle to perform a lane change (e.g., between 1 and 5 seconds, such as 3 seconds). After computing the MLSS, method 750 may proceed to block 761, which comprises determining if the distance from the first vehicle to the second vehicle is greater than the minimum longitudinal safety threshold distance. If so, then method 750 proceeds to block 762 to detect a left lane change availability condition. In some examples, block 762 may further comprise outputting a signal to a driver that the lane is available, such as via a visual indicator, audible tone, etc. In some examples, block 762 may further comprise performing a driving maneuver responsive to the condition. For example, block 762 may comprise an automated vehicle system directing the host vehicle into the left lane.

In some examples, block 756 may include evaluating a relative angle condition based on the calculated relative angle θ. As illustrated, block 756 comprises determining if the relative angle is within a range defined by an upper and lower threshold. For example, the range may be indicative of a remote vehicle approaching the host vehicle from a neighboring left lane. For example, block 756 may include determining if the relative angle is between a between a first angle threshold between −280° and −260° (e.g., −270°) and a second angle threshold between −180° and −200° (e.g., −190°). If the relative angle is outside the range, the method 750 may return to block 751. If the relative angle is within the range, method 750 may proceed to block 760.

After computing the MLSS, method 750 may proceed to block 763, which comprises determining if the distance from the first vehicle to the second vehicle is greater than the minimum longitudinal safety threshold distance. If so, then method 750 proceeds to block 764 to detect a right lane change availability condition. In some examples, block 764 may further comprise outputting a signal to a driver that the lane is available, such as via a visual indicator, audible tone, etc. In some examples, block 764 may further comprise performing a driving maneuver responsive to the condition. For example, block 764 may comprise an automated vehicle system directing the host vehicle into the right lane.

FIG. 7E illustrates an example method 770 of detecting a traffic jam condition. In particular, method 770 illustrates a method for a host vehicle to detect that it is causing a traffic jam behind it (e.g., a rear traffic jam formation (TRJF) condition). Method 770 may include block 771, which may include receiving BSM messages from multiple remote vehicles and processing the BSMs to retrieve position, velocity, heading, acceleration, turn signal status, etc. Block 771 may further include receiving a road identifier and a speed limit. For example, the road identifier and speed limit may be received as described with respect to method 700.

Method 770 further include block 772, which may include evaluating a velocity condition. For example, block 772 may comprise determining if the host vehicle is traveling below the speed limit. As another example, block 772 may comprise determining if the host vehicle is traveling below a threshold determined based on the speed limit (e.g., 5-10 mph less than the speed limit). If not, the method returns to block 771. If so, the method proceeds to block 774.

Block 774 may comprise computing a rear traffic jam distance y. For example, the rear traffic jam distance may be determined based on the host vehicle's current speed. For example, y may be computed as a safe following distance for the host vehicle. For example, y may be a safe following distance for a single remote vehicle. For instance, the rear jam distance may be between 10-30 m, etc. Method 770 further includes block 774, which includes determining if the number of vehicles within the rear traffic jam distance is greater than a threshold count. For example, block 775 may include determining if 2 or more remote vehicles are following the host vehicle within the rear traffic jam distance.

Method 770 may further include block 775, which may include evaluating a heading condition based on the calculated heading difference α (e.g., as described with respect to block 405, 707). As illustrated, block 775 includes determining if the heading difference is within a range indicative of the remote vehicles traveling the same direction as the host vehicle (e.g., block 775 may be performed for each remote vehicle within the rear jam distance). For example, the first heading threshold may be between −3° and 0° (e.g., −1°) and a second heading threshold may be between 3° and 7° (e.g., 5°). If a is outside the range, then method 770 returns to block 771. If a is within the range, then method 770 proceeds to block 776.

In some examples, block 776 may include evaluating a relative angle condition based on the calculated relative angle θ. As illustrated, block 776 comprises determining if the relative angle is within a range defined by an upper and lower threshold. For example, the range may be indicative of a remote vehicle being in the same lane as the host vehicle. For example, block 755 may include determining if the relative angle is between a first angle threshold between −180° and −160° (e.g., −175°) and a second angle threshold between −200° and −180° (e.g., −185°). For example, the range may comprise a range of about 5°. If the relative angle is outside the range, the method 770 may return to block 771. If the relative angle is within the range, method 770 may proceed to block 777.

Block 777 may comprise detecting an RUF condition. Further, block 777 may include warning the driver if they are causing a traffic jam to occur, such as via a visual indicator, audio tone, haptic feedback, etc. In some examples, block 777 may include performing an automated vehicle maneuver, such as accelerating (e.g., to the speed limit), changing lanes (e.g., out of a left lane), etc. For instance, block 777 may comprise performing method 750 to determine if there is an available lane.

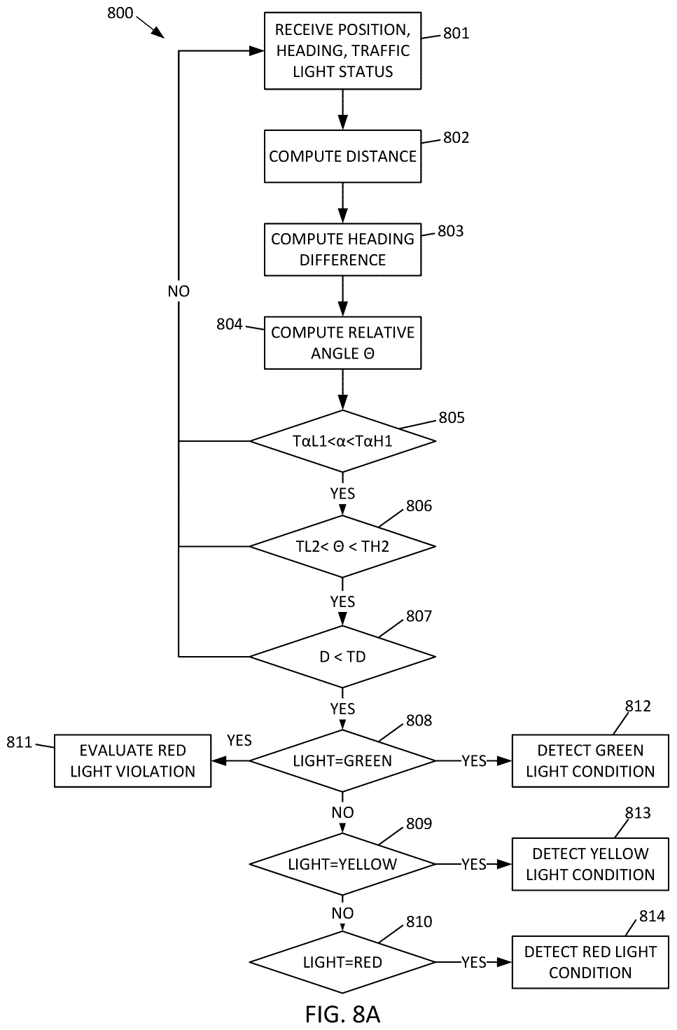

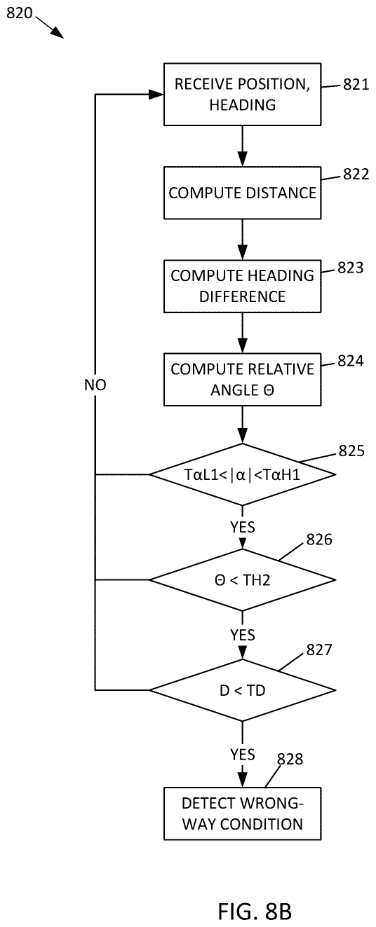

FIG. 8A illustrates an example method 800 of detecting traffic light status conditions and red light violation conditions. For example, method 800 may comprise an implementation of method 100, 400, etc. in a V2I environment. For example, method 800 may be performed by a host vehicle approaching a traffic light, such as at an intersection as illustrated in FIG. 6A. In this example, method 800 may comprise block 801, which may include receiving position, heading information, and traffic light status from an RSU associated with a traffic light (e.g., as described with respect to blocks 101, 401, etc.). For example, block 801 may comprise receiving a communication from an RSU embedded in the traffic light or disposed in an area near the traffic light and calibrated to broadcast BSMs providing information about the traffic light. As described above, the heading may comprise the heading of the direction that the traffic points (e.g., the direction of oncoming traffic). Method 800 may further include block 802, which may include computing a distance to the traffic light (e.g., as described with respect to blocks 102, 302, 402 etc.). As indicated above, the distance to the traffic light may be different than the distance to the RSU sending the traffic light information (e.g., when the RSU is not collocated with the traffic light). Method 800 may further include block 803, which may include computing a heading difference between the host and the traffic light (e.g., as described with respect to block 404, etc.) and block 804, which may include computing a relative angle between the host and traffic light (e.g., as described with respect to block 104, 304, 406, etc.).

In some examples, method 800 may include block 805 may include evaluating a heading condition based on the calculated heading difference α (e.g., as described with respect to block 405, 707). As illustrated, block 805 includes determining if the heading difference is between a lower heading threshold and a higher heading threshold indicative of facing the host vehicle. For example, evaluating the heading difference condition may include determining if an absolute value of the heading difference is between a first heading threshold between 125° and 145° (e.g., 135°) and a second heading threshold between 170° and 190° (e.g., the first heading threshold (e.g., upper threshold for negative angles) may be between −70° and −85° (e.g., −78°) and the second heading threshold (e.g., lower threshold) may be between −90° and −100 (e.g., −93°). If a is outside the range, then method 800 returns to block 801. If a is within the range, then method 800 proceeds to block 806.

In some examples, block 806 may include evaluating a relative angle condition based on the calculated relative angle θ. As illustrated, block 806 comprises determining if the relative angle is within a range defined by an upper and lower threshold. For example, the range may be indicative of the traffic light being ahead of the host vehicle and being associated with the intersection to which the host vehicle is approaching. For example, block 806 may include determining if an absolute value of the relative angle is between a first angle threshold between 0° and 3° (e.g., 0°) and a second angle threshold between 40° and 50° (e.g., 45°). If the relative angle is outside the range, the method 800 may return to block 801. If the relative angle is within the range, method 800 may proceed to block 807.

Block 807 may include evaluating a distance condition. For example, in this example, block 807 may include determining if the distance is less than a threshold distance. For example, the threshold distance may be an approach distance for a traffic light (e.g., a distance providing sufficient time for a driver/automated system to decide to stop or continue through the intersection). For example, the threshold distance may be a user configurable parameter, the threshold distance may be determined according to a particular vehicle or vehicle type (e.g., a small car may have a smaller distance threshold than a large truck), etc. For example, block 807 may include determining if the distance from first vehicle to the traffic light is less than a threshold distance between 75 m and 120 m (e.g., 100 m). In the illustrated example, if the distance exceeds the threshold, the method returns to block 801. If the distance meets the condition, then the traffic light is identified as a traffic light for the host vehicle and the method proceeds through blocks 808, 809, 810 to determine a traffic light status.

Block 808 may comprise evaluating the traffic light status received in block 801 to determine if the traffic light is currently green. If so, then method 800 may proceed to block 812 to detect the vehicle safety condition as a green light condition. As indicated above, block 812 may include providing a signal to a driver regarding the status. In some examples, block 812 may further include performing a driving maneuver based on the detected green light condition. For example, block 812 may comprise an automated vehicle driving through the intersection.

In some examples, if a green light is detected in block 808, then the method proceeds to block 811 to determine if a potential red light violation condition exists (e.g., if the vehicle is likely to run a red light if it continues in its current trajectory). For example, block 808 may include determining a stopping distance to an intersection corresponding to the traffic light. For example, the actual distance to the stop line may be different than the distance to the traffic light. A compensation factor, such as an offset distance ‘intr offset’, which is the distance between the stop line and the approaching signal may be used to determine the stopping distance. For example, the stopping distance to the intersection ‘d_intr’ may be obtained by subtracting intr_offset from distance d. Block 811 may further include determining a time to cross the intersection. For example, block 811 may include calculating the time ‘time_intr’ that would be taken by the host vehicle to reach the intersection using distance to intersection ‘dist intr’ and the current speed of the vehicle ‘speed cur’. Further, block 811 may include determining the remaining green time ‘remaining green time’ of the approaching traffic signal from the communication in block 801. If the remaining green time is less than time intr, then redlight violation condition may be detected indicative that the traffic light would change to red before reaching the intersection. In some examples, block 811 may comprise issuing a warning/notification regarding the redlight violation condition. In some examples, block 811 may comprise conducting a vehicle maneuver, such as automatically braking, etc.

If the traffic light is not green, then method 800 proceeds to block 809 to detect if the light is yellow. If so, then method 800 may proceed to block 813 to detect a vehicle safety condition as a yellow light condition. For example, block 813 may include notifying the driver regarding the condition or conducting a vehicle maneuver (e.g., decelerated or braking). If the traffic light is not yellow, method 800 may proceed to block 810, which may include detecting whether the traffic light is red. If so, method 800 may proceed to block 814, which may include notifying the driver regarding the upcoming red light, automatically bringing the vehicle to a stop, etc.

FIG. 8B illustrates an example method 820 of a wrong-way condition as a vehicle safety condition. For example, method 820 may comprise an implementation of method 100, 400, etc. in a V2I environment. For example, method 820 may be performed by a host vehicle based on communications received from roadside beacons, such as the RSU 613 illustrated in FIG. 6B. In this example, method 820 may comprise block 821, which may include receiving position, heading information, from an RSU associated with a road or lane of a road (e.g., as described with respect to blocks 101, 401, etc.). For example, block 821 may comprise receiving a communication from an RSU coupled to a street light, mile marker, or other signage, or otherwise disposed in an area near a road. As described above, the heading may comprise the direction opposite the legal flow of traffic on the road (e.g., a heading broadcast by RSU 613 may point in the direction of oncoming traffic (e.g., towards vehicle 614). Method 820 may further include block 822, which may include computing a distance to the RSU (e.g., as described with respect to blocks 102, 302, 402 etc.). Method 820 may further include block 823, which may include computing a heading difference between the host and the RSU (e.g., as described with respect to block 404, etc.) and block 824, which may include computing a relative angle between the host and RSU (e.g., as described with respect to block 104, 304, 406, etc.).

In some examples, method 820 may include block 825, which may include evaluating a heading condition based on the calculated heading difference α (e.g., as described with respect to block 405, 707). As illustrated, block 825 includes determining if the absolute value of heading difference is between a lower heading threshold and a higher heading threshold indicative of the host vehicle being oriented in a corresponding direction to the RSU. For example, evaluating the heading difference condition may include determining if an absolute value of the heading difference is between a first heading threshold between 0° and 2° (e.g., 0°) and a second heading threshold between 40° and 50° (e.g., 45°). If a is outside the range, then method 820 returns to block 821. If a is within the range, then method 820 proceeds to block 826.

In some examples, block 826 may include evaluating a relative angle condition based on the calculated relative angle θ. For example, as illustrated in FIG. 6B, the relative angle θ between RSU and vehicles driving in the legal flow of traffic is always positive. Thus, block 826 comprises determining if the relative angle negative or less than an angle threshold between 0° and 2 (e.g., 0°). If the relative angle exceeds the threshold, the method 820 may return to block 821. If the relative angle meets the threshold, method 820 may proceed to block 827.

Block 827 may include evaluating a distance condition. For example, in this example, block 323 may include determining if the distance is less than a threshold distance. For example, the threshold distance may be a typical distance between RSU beacons, a distance between a road egress point (e.g., the ingress point for a wrong-way driving situation), or other distance threshold. For example, block 827 may include determining if the distance from first vehicle to the RSU is less than a threshold distance between 10 m and 200 m (e.g., between 20 m and 100 m, such as 50 m). In the illustrated example, if the distance exceeds the threshold, the method returns to block 821. If the distance meets the condition, then a wrong way vehicle status condition is detected (e.g., it is detected that the host vehicle is traveling the wrong way down a road). In some examples, block 821 may comprise outputting a warning to the driver (e.g., via an audible signal, haptic feedback, visual signal, etc.) In some examples, block 821 may comprise performing an automated driving maneuver. For example, block 821 may comprise automatically pulling over a road shoulder and stopping, etc.

While various vehicle safety condition detection methods have been illustrated as independently performed, in some examples steps of the methods may be combined. For example, blocks 301, 311, [ . . . ], may be performed as a combined step, multiple conditions may be evaluated simultaneously/sequentially (e.g., as a switch case condition for different distance thresholds, angle ranges, etc. . . . ), etc. As another example, an FC and EEBL condition may be based on the same distance thresholds, and blocks 312, 322 and 313, 323 may be performed as single operations. Various example methods are described herein with respect to orderings as illustrated. However, these methods are not limited to a certain order or conditional flow. For instance, blocks may be performed in any consistent order, including consistent parallel or sequential ordering. As another example, evaluation blocks may be performed in any logically consistent manner, such as by joint conditions, switch cases, etc. The description of components of such devices and systems is intended to be illustrative only, and neither a minimum nor limit of the types of components that could be used in various embodiments hereof. Similarly, the methods described herein are explained with reference to optional steps and modifications, none of which are intended to be limiting or required. The methods described herein can be performed using hardware such as (or including) the devices and systems described herein but need not be implemented through such hardware except in specific examples that identify the use of such hardware.

While, as described above, vehicle sensing capabilities have been a substantial consideration in driver assistance and autonomous vehicle approaches, utilizing vehicle data/informational connectivity may present a more robust platform that can be leveraged for supporting vehicle safety-related condition detection. Thinking of vehicles as smart devices, such as treating vehicles as IoT edge devices, can address a number of issues precluding the successful development of such system.

The term “Internet of Things” (IoT) refers to the data sharing between physical devices connected via the Internet (or similar local networks that may be connected to the Internet). The number of physical devices that are leveraging connection to the Internet in the IoT field is rising quickly. However, to date, most research and develop in this area has focused on small, resource-constrained, dedicated-purpose devices, such as appliances, camera systems, smart home devices, etc.

Devices that operate within the IoT architecture can be thought of as falling into one or more of three basic categorizations: 1. Edge Layer devices (Contains edge nodes, which are smart objects, sensors, and actuators). IoT devices in this category are generally physical devices that perform some task (e.g., sensing, display/notifications to users, etc.) and, as a result, perform some computation on their own, also known as edge computing. 2. Fog Layer devices (Contains network-connected communication and processing units also known as fog nodes). Using fog nodes, data from edge nodes (which, themselves, may not be directly connected to the Internet, but rather rely on a Fog Layer device for Internet connectivity and/or other support) is uploaded to the cloud which is also known as fog computing. 3. Cloud Layer devices (e.g., virtual servers, physical servers, cloud resources, web-based portals, etc.). In this layer, applications and analytics are built using data from fog nodes.

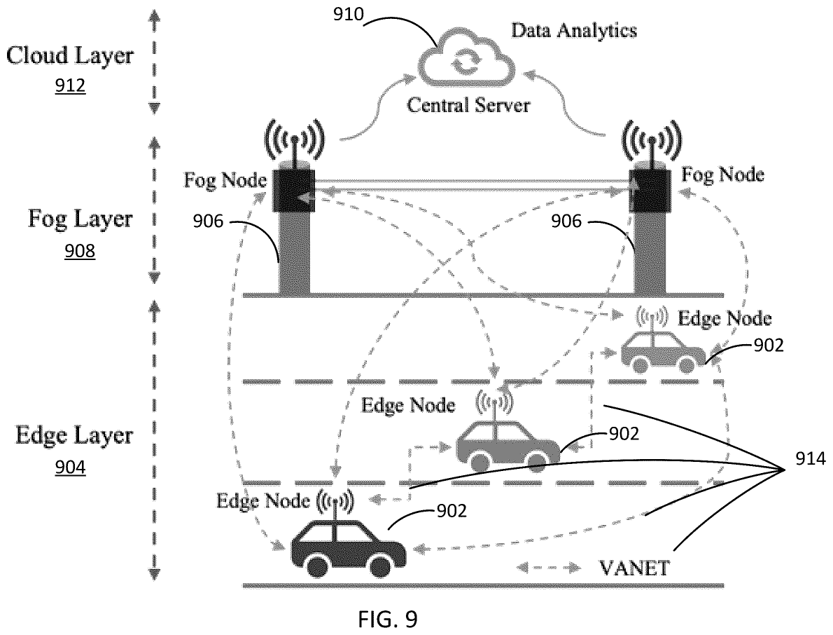

As shown in FIG. 9, the IoT concept mentioned above can be applied to vehicles, where each vehicle can function as an edge node. For example, FIG. 9 illustrates an example environment in which various methods described above. While FIG. 9 illustrates an example environment for V2V communications, the example environment may include and the description may apply to V2I communications as well. However, with the classic approach of considering edge nodes as the bottom “tier” of the IoT hierarchy, requiring fog nodes and/or a cloud layer, several limitations still exist. For example, as shown in FIG. 9, each vehicle 902 may be part of an Edge Layer 904, such that they are each connected to one or more fog nodes 906 of a Fog Layer 908. These fog nodes 906 would be physical infrastructure, such as roadside transceivers, that provide instructions to the vehicles 902. The fog nodes 906, would then be connected to a centralized server 910 of a cloud layer 912, which coordinates the activity instructions sent to the vehicles 902. However, this approach still relies on several factors that limit its ability to overcome the limitations described above. For example, significant infrastructure is required, and each vehicle still relies on its own sensors to platoon, even though the vehicle is taking instructions from a centralized server. Each vehicle that is not directly connected to the fog layer device would be reliant on the intermediate vehicle, thus making it necessary that the two vehicles have the same origination and destination points and will travel together continuously.

Vehicle-to-vehicle communication (rather than solely vehicle-to-fog layer device) can help improve on the foregoing approach. As one example, platooning achieved through an IoT regime (e.g., Internet of Vehicles (IoV)), where vehicles and roadside systems are connected through vehicular ad hoc networks (VANETs) 914 as shown can be utilized to extend reach of fog layer devices, and thereby somewhat reduce the need for extensive infrastructure. Using vehicle-to-everything (V2X) connections, each vehicle in the IoV is considered a smart object that is installed with sensor platforms, processing facilities, control units, and storage. However, even using vehicle-to-vehicle communication to extend fog systems does not overcome the limitations described above. In fact, in some ways it could exacerbate some of the issues, as a wide range of industry sectors, including transportation, automobile manufacturing, energy, automation, software, and information and communication technology, would need to coordinate to achieve such a regime, and all would be significantly impacted by this approach.

Furthermore, the systems and methods disclosed herein may be utilized with a variety of approaches to automated driving systems. The Society of Automotive Engineers (SAE) defines six levels of autonomy, with level zero meaning no autonomy; level one being driver assistance that controls steering or speed (e.g., adaptive cruise control); level two being partial automation, which includes simultaneous control of steering and speed (e.g., ADAS systems that combine lane-centering and adaptive cruise control); level three being conditional automation (controlling all driving tasks, under specific conditions); level four being high automation, in which the vehicle controls all driving tasks and monitors the environment without driver intervention; and level five meaning complete autonomy. As described above, various embodiments may be usable by vehicles/drivers of any of the six levels of autonomy, including mixed groups of vehicles having different autonomy levels.

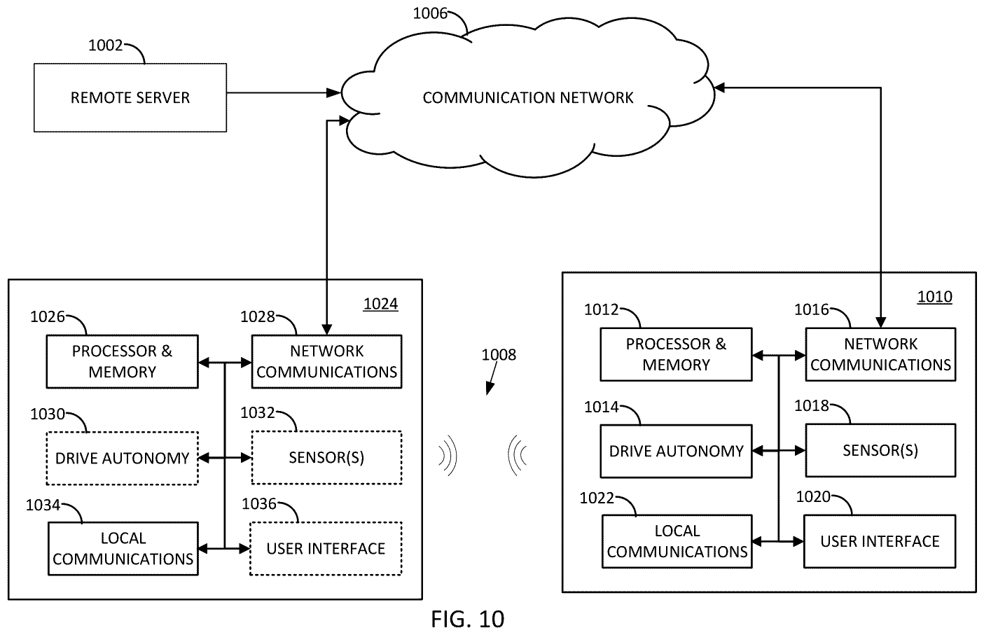

Referring now to FIG. 10, a block diagram is shown illustrating a system architecture for implementing the methods described above with respect to FIGS. 1-8. The system comprises a first vehicle 1010 and a V2X object 1024, both of which may perform some or all of the steps of the methods describe above. For example, object 1024 may comprise a second vehicle or may comprise an infrastructure element (e.g., RSU). The vehicle 1010 and object 1024 communicate locally with one another via a dedicated local broadcast protocol 1008 (e.g., a V2X communication protocol to exchange messages such as BSMs) and, optionally, with a remote server 1002 via an internet communication network 1006.

Vehicle 1010 includes an integrated system comprising hardware and software components for executing various methods described above. This system may be capable of operating natively using the vehicle's existing original equipment manufacturer (OEM) hardware and software. Key components of vehicle 1010 include a processor and memory module 1012 for executing logic and maintaining operational data, a network communications module 1016 for managing external communications. In some examples, a vehicle 1010 may further include a drive autonomy module 1014 for controlling vehicle movement at various levels of automation (ranging from Level 2 to Level 5 autonomy). For example, autonomy module 1014 may execute various automatic vehicle maneuvers as described above. While, as described above, the described methods may be performed based on V2X communications without active sensing, they do not preclude active sensing. Accordingly, vehicle 1010 may include a sensor array 1018. The sensor array may include cameras, LIDAR, radar, or other sensing equipment for detecting surrounding vehicles and road conditions. The vehicle further includes a user interface 1020, which may provide feedback to a driver or display status updates regarding vehicle operations or vehicle safety conditions. For example, as described above, user interface 2020 may include a steering wheel, a dashboard, visual indicators present throughout a vehicle's cockpit, speakers, etc.

In an example where object 1024 comprises a vehicle, vehicle 1024 may comprise a second host vehicle or a remote vehicle, may be similarly equipped for participating in the described methods. In one implementation, vehicle 1024 includes integrated hardware components analogous to those of vehicle 1010. These components include a processor and memory module 1026, a drive autonomy module 1030, a network communications module 1028, a local communications module 1034, a sensor array 1032, and a user interface 1036. Alternatively, vehicle 1024 may operate using an aftermarket device that executes the methods independently of the vehicle's onboard systems. In such a configuration, the aftermarket device may communicate instructions to the driver via the user interface 1036, prompting manual adjustments to vehicle controls as necessary. This approach may enable vehicles without native V2X capabilities to participate in the V2X environment.

In an example where object 1024 comprises an infrastructure element 1024 (e.g., a beacon for a traffic light, wrong way beacon, etc.) element 1024 may include similar components to participate in V2X communications. For example, element 1024 may include integrated hardware components to broadcast V2I messages. These components may include a processor and memory module 1026, a local communications module 1034, a network communications module 1028 and a user interface 1036. For example, memory and processor 1026 may store instructions to broadcast calibrated beacon messages associated with an infrastructure element, as described above.

Vehicles 1010 and object 1024 may communicate locally 1008 through a dedicated local communications module 1022 in vehicle 1010 and a corresponding module 1034 in pbkect 1024. These modules may utilize communication protocols such as Dedicated Short Range Communication (DSRC) to enable low-latency, direct vehicle-to-vehicle (V2V) communication. This local communication facilitates the real-time exchange of Basic Safety Messages (BSMs), which include data such as position, speed, heading, acceleration, braking status, traffic light status, etc. as described above.

In addition to direct V2X communication, both vehicle 1010 and object 1024 may optionally connect to a remote server 1002 via the internet communication network 1006. For example, the server 1002 may facilitate the management of V2X communication services, including vehicle registration, user identification, beacon calibration, and verification credential management. The server may also maintain information about vehicle ratings and safety scores, which may include aggregated data on driving behavior, historical performance, and user feedback. Additionally, the server 1002 may store data on vehicle capabilities, such as automation level, sensor configurations, and energy efficiency metrics.

The remote server 1002 also includes its own processor and memory for executing platform management algorithms and protocols. The server interfaces with vehicle 1010 and object 1024 through the network 1006, providing a centralized repository for managing V2X-related data while allowing decentralized execution of methods by the vehicles themselves.

This system architecture enables seamless coordination between vehicles operating host vehicles or remote vehicles, whether they possess native or aftermarket platooning capabilities. The integration of local V2X communication with optional internet-based connectivity to the remote server ensures robust, scalable, and adaptable platoon management across diverse vehicle types and configurations.

In some embodiments, the processors 1012, 1026 of the objects can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. The processors may reflect general-purpose computational resources that control the entire vehicle, or may be dedicated processing resources for managing platooning functions. Similarly, the memory can include any suitable storage device or devices that can be used to store suitable data (e.g., software to run the functions described above, user settings or predefined requirements and preferences for platoon drive characteristics, route mapping information, sensor data, and any other data or information used in performing the types of platooning described herein). The memory can include a non-transitory computer-readable medium including any suitable volatile memory, non-volatile memory, storage, or any suitable combination thereof. For example, memory 1012, 1026 can include random access memory (RAM), read-only memory (ROM), electronically-erasable programmable read-only memory (EEPROM), one or more flash drives, one or more hard disks, one or more solid state drives, one or more optical drives, etc.

The network communications systems of the vehicles can include any suitable hardware, firmware, and/or software for communicating information over the Internet communication network 1006 and/or any other suitable communication networks. For example, the communications systems can include one or more transceivers, one or more communication chips and/or chip sets, etc. In a more particular example, the communications system 1016 can include hardware, firmware and/or software that can be used to establish a Wi-Fi connection, a Bluetooth connection, a cellular connection (e.g., a 3G network, a 4G network, a 5G network, etc., complying with any suitable standard, such as CDMA, GSM, LTE, LTE Advanced, NR, etc.), a satellite connection, combinations thereof, etc. In some embodiments, the communications system may be native to the OEM hardware of the vehicle, whereas in other embodiments the communications system may be specific to an aftermarket module or third party device. In some examples, V2X communications may be performed over communications network 1006 rather than, or in combination with, local communications 1008.

The user interfaces of the vehicles may include visual and/or audio presentation to drivers. In some embodiments, the user interfaces may include any suitable display devices, such as a native dashboard display screen, a touchscreen, an infotainment screen, a mobile device, or simple directional and numeric light up indicators, etc. to display information to a driver at various points in performance of the methods described above, such as vehicle safety condition warnings, notifications, etc.

In an example including sensor(s), the sensors of the vehicles may include vision sensors (e.g., optical 2D, stereo, depth, etc. cameras and detectors), infrared sensors, Radar systems, LiDAR systems (3D, solid state, etc.), ultrasonic systems, etc. The sensor(s) may also include GPS modules, IMU-type sensors (accelerometers, gyroscopes, magnetometers), odometry sensors, fuel/charge sensors, traction and ABS sensors, and other native sensors of the vehicle that detect its driving behavior (brake sensors, signaling light sensors, steering sensors, etc.). The sensor(s) may also include environmental sensors, such as rain sensors, temperature sensors, barometers, sunlight/ambient light sensors, acoustic sensors, and the like.

The local communications modules of the vehicles may include transceivers, antennas (omnidirectional, directional, or both), processors, memory, GNSS modules, DSRC onboard units, security and credential management systems, etc. For example, the local communications modules may allow for wireless vehicle-to-vehicle communication to vehicles within a given range, based on local broadcasting of digitized messages modulated onto a given frequency transmission, such as 5.9 GHz frequency band or similar. In some embodiments, the modules may be compliant with IEEE standards such as IEEE 802.11p.

The present technology may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (such as a computer). For example, a machine-readable (such as computer-readable) medium includes a machine (such as a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, Calone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

What is claimed is:

1. A method, comprising:
receiving a communication from an object comprising an object position;
determining a distance from a vehicle to the object based on the communication;
evaluating a distance condition based on the distance;
determining a relative angle of the object from the vehicle;
evaluating a relative angle condition based on the relative angle; and
detecting a vehicle safety condition based on the distance condition and the relative angle condition.

2. The method of claim 1, further comprising:
outputting a user warning based on the vehicle safety condition; or
performing an automated driving maneuver with the vehicle based on the vehicle safety condition.

3. The method of claim 1, wherein determining the relative angle comprises:
determining a position vector between a vehicle position and the object position;
determining a relative heading for the position vector based on the position vector;
determining the relative angle based on a vehicle heading and the relative heading.

4. The method of claim 3, wherein:
the object comprises a second vehicle,
evaluating the distance condition comprises determining if the distance from the first vehicle to the second vehicle is less than a threshold distance between 20 m and 30 m,
evaluating the relative angle condition comprises determining if an absolute value of the relative angle is between a lower threshold between 70° and 100° and an upper threshold between 135° and 155°, and
detecting the vehicle safety condition comprises detecting that the second vehicle is in a blind spot of the first vehicle.

5. The method of claim 3, wherein:
the object comprises a second vehicle,
the communication comprises a second vehicle acceleration,
evaluating the distance condition comprises determining if the distance from the first vehicle to the second vehicle is less than a threshold distance between 40 m and 50 m,
evaluating the relative angle condition comprises determining if an absolute value of the relative angle is less than threshold between 2° and 8°, and
the method further comprises:
evaluating an acceleration condition based on the second vehicle acceleration, and
detecting the vehicle safety condition as an emergency electronic brake light condition based on the acceleration condition.

6. The method of claim 3, wherein:
the object comprises a second vehicle,
the communication comprises a second vehicle velocity,
evaluating the distance condition comprises determining if the distance from the first vehicle to the second vehicle is less than a threshold distance between 40 m and 50 m,
evaluating the relative angle condition comprises determining if an absolute value of the relative angle is less than threshold between 2° and 8°, and the method further comprises:
evaluating a time-to-collision condition based on the second vehicle velocity, and
detecting the vehicle safety condition as a potential forward collision with the second vehicle based on the time-to-collision condition.

7. The method of claim 3, wherein the communication further comprises an object heading and further comprising:
determining a heading difference based on a vehicle heading for the vehicle and the object heading;
evaluating a heading difference condition based on the heading difference; and
detecting the vehicle safety condition based on the heading difference condition.

8. The method of claim 7, wherein:
the object comprises a second vehicle,
the communication comprises a second vehicle velocity,
evaluating the distance condition comprises determining if the distance from the first vehicle to the second vehicle is less than a threshold distance between 40 m and 50 m,
evaluating the heading difference condition comprises determining if an absolute value of the heading difference is less than a first threshold angle between 3° and 7°, evaluating the relative angle condition comprises determining if an absolute value of the relative angle is less than a threshold angle between 0.5° and 2°, and the method further comprises:
determining a speed difference between a speed limit and the second vehicle velocity;
evaluating a speed difference condition based on the speed difference, and
detecting the vehicle safety condition as a slow-moving vehicle condition based on the speed difference condition.

9. The method of claim 8, further comprising:
receiving a second communication from a third vehicle, the second communication comprising a third vehicle heading, a third vehicle position, and a third vehicle velocity; and
responsive to detecting the slow-moving vehicle condition:
determining a second heading difference between the first vehicle and the third vehicle;
evaluating a second heading difference condition based on the second heading difference;
determining a second relative angle between the first vehicle and the third vehicle;
evaluating a second relative angle condition based on the second relative angle;
determining a time-to-collision based on the third vehicle velocity;
evaluating a time-to-collision condition based on the time-to-collision; and
detecting a do-not-pass vehicle condition based on the second heading difference condition, the second relative angle condition, and the time-to-collision condition.

10. The method of claim 7, wherein:
the object comprises a second vehicle,
the communication comprises a second vehicle velocity;
evaluating the relative angle condition comprises determining if an absolute value of the relative angle is between a first angle threshold having an absolute value between 0° and 2° and a second angle threshold having an absolute value between 40° and 55°;
evaluating the heading difference condition comprises determining if an absolute value of the heading difference is between a first heading threshold having an absolute value between 70° and 85° and a second heading threshold having an absolute value between 90° and 100°;
the distance condition comprises a distance and second vehicle velocity condition;
evaluating the distance and second vehicle velocity condition comprises determining if the distance from the first vehicle to the second vehicle is less than a threshold distance between 40 m and 50 m and the velocity is greater than a velocity threshold between 7 m/s and 15 m/s; and
detecting the vehicle safety condition comprises detecting that the second vehicle is crossing an intersection in front of the first vehicle.

11. The method of claim 10, wherein:
evaluating the relative angle condition comprises determining if the relative angle is between the first angle threshold between 0° and −2° and the second angle threshold between −40° and −55°;
evaluating the heading difference condition comprises determining if the heading difference is between the first heading threshold between −70° and −85° and the second heading threshold between −90° and −100°;
the distance condition comprises a distance, second vehicle velocity, and turn signal status condition;
evaluating the distance, second vehicle velocity, and turn signal status condition comprises determining if the distance from the first vehicle to the second vehicle is less than a second threshold distance between 60 m and 80 m, the velocity is greater than the second velocity threshold between 7 m/s and 15 m/s, and the turn signal status is positive; and
detecting the vehicle safety condition comprises detecting the second vehicle entering a right turn trajectory of the first vehicle.

12. The method of claim 10, wherein:
evaluating the relative angle condition comprises determining if the relative angle is between the first angle threshold between 0° and 2° and the second angle threshold between 40° and 55°;
evaluating the heading difference condition comprises determining if the heading difference is between the first heading threshold between 70° and 85° and the second heading threshold between 90° and 100°;
the distance condition comprises a distance, second vehicle velocity, and turn signal status condition;
evaluating the distance, second vehicle velocity, and turn signal status condition comprises determining if the distance from the first vehicle to the second vehicle is less than a second threshold distance between 70 m and 90 m, the velocity is greater than the second velocity threshold between 7 m/s and 15 m/s, and the turn signal status is positive; and
detecting the vehicle safety condition comprises detecting the second vehicle entering a left turn trajectory of the first vehicle.

13. The method of claim 7, wherein:
the object comprises a second vehicle,
evaluating the distance condition comprises determining if the distance from the first vehicle to the second vehicle is greater than a minimum longitudinal safety threshold distance,
evaluating the heading difference condition comprises determining if the heading difference is between a first heading threshold between −3° and 0° and a second heading threshold between 3° and 7°,
evaluating the relative angle condition comprises determining if the relative angle is between a first angle threshold between −180° and −160° and a second angle threshold between −80° and −60°, and
the vehicle safety condition comprises a left lane change clearance condition.

14. The method of claim 7, wherein:
the object comprises a second vehicle,
evaluating the distance condition comprises determining if the distance from the first vehicle to the second vehicle is greater than a minimum longitudinal safety threshold distance,
evaluating the heading difference condition comprises determining if the heading difference is between a first heading threshold between −3° and 0° and a second heading threshold between 3° and 7°,
evaluating the relative angle condition comprises determining if the relative angle is between a first angle threshold between −280° and −260° and a second angle threshold between −180° and −200°, and
the vehicle safety condition comprises a right lane change clearance condition.

15. The method of claim 7, wherein:
the object comprises a traffic light,
the communication comprises a traffic light status
evaluating the distance condition comprises determining if the distance from the first vehicle to the traffic light is less than a threshold between 90 m and 110 m, evaluating the heading difference condition comprises determining if an absolute value of the heading difference is between a first heading threshold between 125° and 145° and a second heading threshold between 170° and 190°,
evaluating the relative angle condition comprises determining if an absolute value of the relative angle is between a first angle threshold between 0° and 3° and a second angle threshold between 40° and 50°, and
the vehicle safety condition comprises the traffic light status.

16. The method of claim 15, wherein the communication comprises a remaining green light time, and further comprising:
determining a stopping distance to an intersection corresponding to the traffic light;
determining a vehicle speed;
determining a time to cross the intersection; and
responsive to the remaining green light time being less than the time to cross the intersection, detecting a red-light violation warning condition.

17. The method of claim 7, wherein:
evaluating the relative angle condition comprises determining if the relative angle is less than an angle threshold between 0° and 2°;
evaluating the heading difference condition comprises determining if an absolute value of the heading difference is between a first heading threshold between 0° and 2° and a second heading threshold between 40° and 50°; and
the vehicle safety condition comprises a wrong-way direction condition.

18. A vehicle, comprising:
a processor; and
a non-transitory computer-readable medium storing instructions executable by the processor to:
receive a communication from an object comprising an object position;
determine a distance from a vehicle to the object based on the communication;
evaluate a distance condition based on the distance;
determine a relative angle of the object from the vehicle;
evaluate a relative angle condition based on the relative angle; and
detect a vehicle safety condition based on the distance condition and the relative angle condition.

19. The vehicle of claim 18, wherein the communication further comprises an object heading and the instructions are executable by the processor to:
determine a heading difference based on a vehicle heading for the vehicle and the object heading;
evaluate a heading difference condition based on the heading difference; and
detect the vehicle safety condition based on the heading difference condition.

20. A non-transitory computer-readable medium storing instructions executable by a processor to:
receive a communication from an object comprising an object position;
determine a distance from a vehicle to the object based on the communication;
evaluate a distance condition based on the distance;
determine a relative angle of the object from the vehicle;
evaluate a relative angle condition based on the relative angle; and
detect a vehicle safety condition based on the distance condition and the relative angle condition.
